(19) United States
(12) Patent Application Publication
(10) Pub. No.: US 2026/0289007 A1
(43) Pub. Date: Sep. 24, 2026

(54) SYSTEM

(71) Applicant: SoftBank Group Corp., Tokyo (JP)

(72) Inventor: Tomo SUZUKI, Tokyo (JP)

(73) Assignee: SoftBank Group Corp., Tokyo (JP)

(21) Appl. No.: 19/567,421

(22) Filed: Mar. 16, 2026

(30) Foreign Application Priority Data
Mar. 19, 2025 (JP) 2025-045086

(51) Int. Cl. G06F 21/62; G06F 8/61; G06F 40/40

(52) U.S. Cl. CPC G06F 21/6245; G06F 8/61; G06F 40/40

(57) ABSTRACT

A system includes a processor that is configured to generate a prompt for performing configuration of a communication terminal on behalf of a user so as to enable use of a generative artificial intelligence, generate a prompt for confirming an opt-out relating to acquisition of personal information and for automatically executing a necessary procedure corresponding to the opt-out, and generate a prompt for recognizing an emotion of a user and adjusting a dialogue with the generative artificial intelligence on the basis of an analysis result of the emotion.

### CROSS-REFERENCE TO RELATED APPLICATION

This application is based on and claims priority under 35 USC 119 from Japanese Patent Application No. 2025-045086 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for configuring communication terminals and enabling the use of generative artificial intelligence require users or store staff to manually perform complicated setup operations, such as installing applications, setting access permissions, and adjusting privacy options. As a result, many users, particularly those who are unfamiliar with digital technologies, encounter difficulties in starting to use generative artificial intelligence services smoothly. In addition, conventional systems do not adequately support confirmation and execution of opt-out procedures relating to acquisition of personal information, so that users may not be able to appropriately protect their privacy in accordance with their intentions. Furthermore, conventional systems generally do not recognize or respond to the emotional state of the user, and therefore cannot dynamically adjust prompts or dialogues with generative artificial intelligence in a manner tailored to the user's emotional condition. Consequently, user burden and anxiety remain high, the usability and acceptance of generative artificial intelligence are reduced, and an opportunity to provide more personalized guidance, such as emotionally adaptive instructional videos, is missed.

### SUMMARY

In order to solve the above-described problems, a system according to one aspect of the present invention comprises a processor, wherein the processor is configured to generate a prompt for performing configuration of a communication terminal on behalf of a user so as to enable use of a generative artificial intelligence. By automatically generating such a prompt, the system allows the configuration of the communication terminal, which includes installation and initial setup of a generative artificial intelligence application, to be executed without requiring the user to manually perform complex operations. The processor is further configured to generate a prompt for confirming an opt-out relating to acquisition of personal information and for automatically executing a necessary procedure corresponding to the opt-out. Accordingly, the system can guide or trigger a procedure that reflects the user's privacy preference and can automatically perform or assist in performing registration or change of privacy settings with respect to the generative artificial intelligence service. In addition, the processor is configured to generate a prompt for recognizing an emotion of a user and adjusting a dialogue with the generative artificial intelligence on the basis of an analysis result of the emotion. As a result, the system can adapt the interaction style, content, and tone of the dialogue to the emotional state of the user, thereby reducing anxiety and improving user satisfaction. In some embodiments, the processor is further configured to generate a prompt for providing a video that explains a usage method of the generative artificial intelligence and for adjusting content or tone of the video in accordance with the emotion of the user, and to generate a prompt for performing, via a configuration agency service provided at a specific communication terminal retail store, a remote configuration of a terminal of the user. Through these functions, the system collectively enables easy introduction of generative artificial intelligence to a user's communication terminal, secure handling of personal information in accordance with opt-out preferences, and emotionally adaptive guidance that improves the usability and acceptance of generative artificial intelligence services.

The term “system” refers to a combination of one or more hardware components and software components that cooperate to perform processing related to configuration of a communication terminal, handling of personal information, emotion recognition, and interaction with a generative artificial intelligence.

The term “processor” refers to one or more hardware processing units, such as a central processing unit (CPU), microprocessor, or dedicated processing circuitry, that execute instructions to perform the functions described in the claims, including generating prompts and controlling system operations.

The term “communication terminal” refers to an electronic device capable of wireless or wired communication, such as a smartphone, tablet, mobile phone, or similar device, that is used by a user to access services including generative artificial intelligence.

The term “prompt” refers to electronic data, including instructions, messages, or queries, that is generated by the processor to cause another system, application, or user interface to perform a specific operation, to display particular guidance, or to control behavior of a generative artificial intelligence.

The term “generative artificial intelligence” refers to an artificial intelligence system or model that is capable of generating content such as text, audio, images, or other data in response to input, and that supports interactive dialogue or content creation for the user.

The term “opt-out relating to acquisition of personal information” refers to a user's decision or setting to refuse or limit the collection, storage, or use of personal information by a service, application, or generative artificial intelligence system.

The term “necessary procedure corresponding to the opt-out” refers to one or more operations that must be carried out in a system or service, such as updating settings, sending requests to an external server, or modifying stored data, in order to implement the user's opt-out preference concerning personal information acquisition.

The term “personal information” refers to information relating to an identified or identifiable individual, including but not limited to name, address, contact information, identifiers associated with a device, or other data that can directly or indirectly identify a user.

The term “emotion of a user” refers to an affective state of the user, such as happiness, anxiety, frustration, confidence, or similar emotional conditions, which can be inferred from user behavior, speech, text, physiological signals, or other observable data.

The term “recognizing an emotion of a user” refers to detecting and classifying the emotional state of the user by analyzing data such as textual input, voice characteristics, facial expressions, interaction patterns, or other signals using predetermined rules or machine learning models.

The term “analysis result of the emotion” refers to a determined classification or parameter set that represents the user's emotional state, derived from processing input data, and used as a basis for adjusting prompts, dialogues, or content.

The term “adjusting a dialogue with the generative artificial intelligence” refers to modifying one or more aspects of an interaction, including response style, wording, level of detail, pacing, or guidance, between the user and the generative artificial intelligence, based on the recognized emotional state.

The term “video that explains a usage method of the generative artificial intelligence” refers to audiovisual content that provides instructions, demonstrations, or guidance on how to operate, interact with, or effectively utilize the generative artificial intelligence system.

The term “content or tone of the video” refers to elements of the video including the information presented, examples used, level of detail, speech style, narration manner, visual emphasis, and emotional nuance conveyed to the viewer.

The term “configuration agency service provided at a specific communication terminal retail store” refers to a service offered by a particular physical retail location that sells communication terminals, in which staff or automated systems perform initial setup, configuration, or adjustment of the user's communication terminal on behalf of the user.

The term “remote configuration of a terminal of the user” refers to performing configuration operations on the user's communication terminal from a different device or server, via a network connection, without requiring direct manual input on the user's terminal by the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

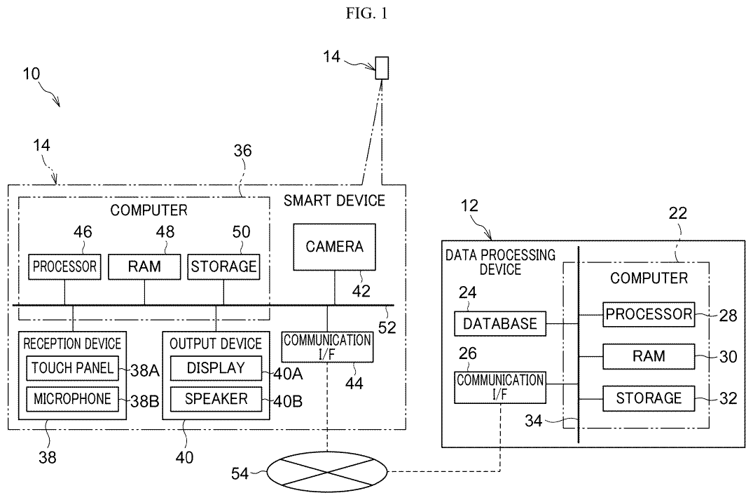

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

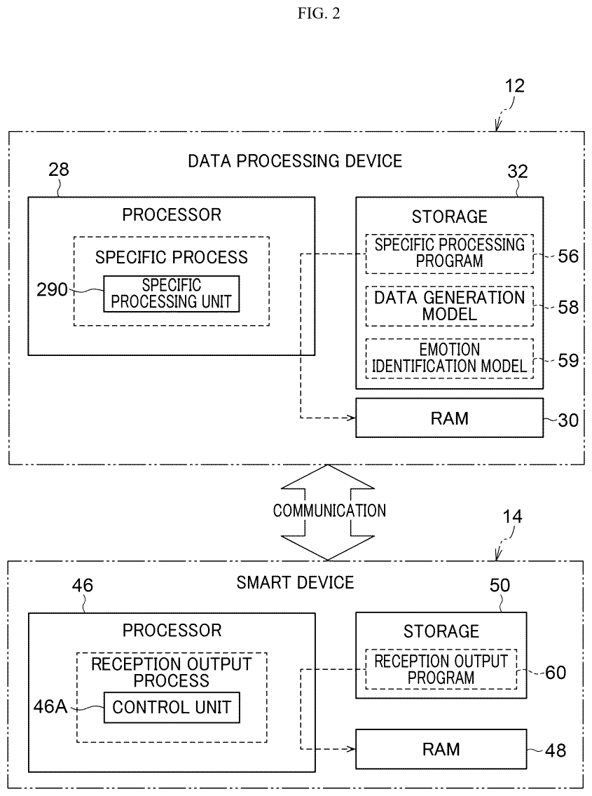

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional communication environments, deployment and use of a generative AI model on a communication device require multiple fragmented configuration operations on both a server side and a device side. A user or an operator is typically required to manually select and install an appropriate application, configure network endpoints and authentication parameters, enable or disable logging of prompt sentences and usage history, and separately confirm or execute personal information opt-out procedures. These operations are often performed via heterogeneous user interfaces and ad hoc scripts, which leads to several technical problems in the underlying computer technology.

First, there is no unified mechanism by which a server can generate and deliver a device-specific and user-specific configuration executable that coordinates application installation, connection settings to a generative AI model, and privacy control parameters in an integrated fashion. As a result, communication devices must perform additional processing to reconcile server defaults, locally stored user preferences, and application-internal settings. This causes redundant data access and repeated network transactions, increasing processing load on processors, memory usage, and network bandwidth consumption, and also causing delays before the generative AI model becomes available for interaction.

Second, conventional systems lack a server-controlled linkage between privacy preferences and the internal logging and access behavior of the generative AI model. Even when a user selects an opt-out option for personal data acquisition on a device, that selection is not consistently propagated as structured control information to the server-side model execution environment. Consequently, server components may still generate, store, or replicate usage records or prompt sentences in logs or training datasets, thereby increasing the amount of data that must be processed, stored, and filtered. This leads to inefficiencies in data management subsystems and complicates enforcement of privacy constraints at the infrastructure level.

Third, known systems do not tightly integrate instructional content delivery with the configuration flow of the generative AI model. Instructional videos and help texts explaining how to input a prompt sentence, how to interpret model responses, and how to adjust privacy options are typically provided through separate web resources or generic help pages. As a result, the communication device must perform additional browsing, content searching, and UI navigation operations, which introduce extra computation and network overhead. Furthermore, because such help content is not consistently tailored using device attributes and user attributes on the server side, the device may need to locally filter or adapt content, increasing local processing complexity and memory consumption.

Fourth, in remote configuration support services, there is no standardized mechanism for a management terminal to act as a controlled relay for device-specific configuration commands and application acquisition information generated on the server. This often requires custom remote-control software that duplicates configuration logic on the management terminal or requires manual input by an operator, which leads to inconsistent device states, redundant computations, and inefficient use of network resources when deploying generative AI applications to multiple communication devices.

Accordingly, there is a need for computer technology that improves the way a server and a communication device cooperate to deploy and configure a generative AI model. In particular, there is a need for a server-implemented mechanism that (i) generates configuration commands embedding device-specific and user-specific settings, (ii) embeds privacy control information that directly governs logging and storage behavior for prompt sentences and usage history at the model execution layer, (iii) associates instructional content identifiers with the same configuration commands, and (iv) supports efficient remote deployment via a management terminal. By addressing these problems, the overall computer system can reduce redundant processing, simplify configuration flows, and enforce privacy controls with reduced computational and networking overhead.

The specific processing by the specific processing unit 290 of the data processing device 12 in Example 1 is realized by the following means.

The present invention provides a server comprising a processor configured to acquire terminal attribute information and user attribute information from a communication device, determine introduction and configuration content of a generative information processing function for the communication device based on the terminal attribute information and the user attribute information, and generate configuration information processing commands including a result of the determination; to identify a generative information processing application program to be installed on the communication device based on identification information of an application program obtainable from an information distribution infrastructure, generate application program acquisition information associated with the configuration information processing commands, and add control information into the configuration information processing commands for causing a configuration execution program operating on the communication device to automatically execute installation processing of the generative information processing application program and connection setting processing to the generative information processing function; to generate privacy control information indicating permission or prohibition of storage of usage history information and prompt sentence information for the generative information processing function based on a selection state regarding acquisition of personal information included in the user attribute information, apply the privacy control information to the configuration information processing commands and to the generative information processing application program, and thereby cause a generative information processing model executed on a server-side model execution environment to control logging and storage behavior according to the privacy control information; to store video information and text information explaining a usage method of the generative information processing function on the communication device, select reference identification information for the video information and the text information according to the terminal attribute information and the user attribute information, and provide the reference identification information in association with the configuration information processing commands so that the communication device can display a support screen explaining a method of inputting a prompt sentence to the generative AI model, a method of interpreting response information, and a method of setting privacy options; to receive a processing request including prompt sentence information transmitted from the communication device after execution of the configuration information processing commands, determine processing execution conditions for the generative information processing model based on the prompt sentence information and the privacy control information, cause the generative information processing model to execute response information generation processing, transmit a result of the response information generation processing to the communication device, and, in accordance with the privacy control information, selectively store, anonymize, or discard the prompt sentence information and the response information in a storage resource; and to acquire setting state information recorded on the communication device and setting change information by a user as a result of execution of the configuration information processing commands, and update the privacy control information and access conditions to the generative information processing model based on the setting state information and the setting change information. This enables an integrated server-side control mechanism in which device-specific and user-specific configuration, application deployment, privacy enforcement, and instructional content association are centrally generated and managed, thereby reducing redundant processing on the communication device, lowering network overhead for configuration and logging, and improving efficiency and reliability of deploying and operating a generative AI model that processes prompt sentences under user-defined privacy constraints.

The term “system” refers to a collection of one or more information processing apparatuses, including at least a server apparatus with a processor and memory, and optionally one or more communication devices and management terminals, which cooperate via a communication network to execute functions described in the claims.

The term “processor” refers to one or more hardware processing units, such as a central processing unit, a graphics processing unit, or a dedicated processing circuit, configured to execute instructions stored in a memory to perform data processing operations defined in the claims.

The term “communication device” refers to an electronic apparatus having communication capability, such as a mobile terminal, a portable information terminal, or a fixed information terminal, that can install and execute application programs and can exchange data with a server via a communication network.

The term “terminal attribute information” refers to information indicating one or more attributes of the communication device, including at least a device type, an operating system type or version, a hardware resource condition, a language environment, or a region setting.

The term “user attribute information” refers to information indicating one or more attributes of a user associated with the communication device, including at least a user identifier, a region, a language preference, and a selection state regarding acquisition or use of personal information.

The term “generative information processing function” refers to a function that uses a generative AI model to generate information, such as text, audio, or other content, based on input data including a prompt sentence provided from the communication device. The term “configuration information processing commands” refers to information, including instructions, parameters, and control data, generated by the processor on the server side, which is interpreted by a configuration execution program on the communication device to perform installation, setting, and connection processing related to the generative information processing function.

The term “application program acquisition information” refers to information indicating how to obtain a generative information processing application program, including at least identification information of the application program and a location or procedure for downloading or retrieving the application program from an information distribution infrastructure.

The term “information distribution infrastructure” refers to a server system or service platform that distributes application programs or digital content to communication devices via a communication network.

The term “generative information processing application program” refers to an application program installed on the communication device and configured to provide a user interface for inputting a prompt sentence, to communicate with a generative AI model, and to present generated response information to a user.

The term “configuration execution program” refers to a program or module executing on the communication device, which interprets the configuration information processing commands and performs automatic processing including installation, setting, and connection to the generative information processing function.

The term “connection setting processing” refers to processing for establishing and configuring communication between the communication device and the generative information processing function, including at least setting of a communication endpoint, an authentication parameter, and a protocol parameter.

The term “privacy control information” refers to information indicating a control policy regarding storage, use, or transmission of data related to a user, including at least permission or prohibition of storage of usage history information and prompt sentence information in association with the generative information processing function.

The term “usage history information” refers to information indicating usage records of the generative information processing function, including at least timestamps, operation types, or identifiers related to prompt sentences and response information.

The term “prompt sentence information” refers to information representing an instruction or query input by a user, or generated based on user input, and transmitted from the communication device to the generative AI model for generation of response information.

The term “video information” refers to data representing moving image content configured to visually explain a usage method or operation method of the generative information processing function on the communication device.

The term “text information” refers to data representing textual content configured to describe instructions, explanations, or guidance regarding the generative information processing function.

The term “reference identification information” refers to information, such as a content identifier, a uniform resource locator, or an index value, that enables the communication device to access or retrieve corresponding video information or text information stored on the server or on another storage resource.

The term “processing request” refers to a request transmitted from the communication device to the server, including at least prompt sentence information and optionally additional parameters, instructing execution of processing by the generative information processing model.

The term “generative information processing model” refers to a trained computational model, such as a machine learning model or neural network, capable of generating output information based on input information including a prompt sentence.

The term “response information generation processing” refers to processing performed by the generative information processing model to generate response information, such as generated text or other content, from input information including a prompt sentence.

The term “setting state information” refers to information recorded on the communication device indicating a current state of one or more settings related to the generative information processing function, including at least privacy options, connection parameters, and notification preferences.

The term “setting change information” refers to information indicating one or more changes made by a user to settings related to the generative information processing function after execution of the configuration information processing commands.

The term “access conditions to the generative information processing model” refers to conditions or constraints under which the generative information processing model may be invoked, including at least authorization conditions, rate limits, and restrictions based on privacy control information.

The term “support screen” refers to a user interface screen displayed on the communication device, configured to present guidance including instructions for inputting a prompt sentence, interpreting response information, and operating privacy or configuration options. The term “screen configuration information” refers to information defining a layout, structure, or visual arrangement of elements of the support screen displayed on the communication device.

The term “guidance control information” refers to information used to control timing, content, or behavior of guidance presented on the support screen, including at least which explanatory elements to show and in what sequence.

The term “management terminal” refers to an information processing apparatus used in a remote configuration support service, configured to relay terminal attribute information, user attribute information, configuration information processing commands, and application program acquisition information between the server and one or more communication devices.

The term “remote configuration support service” refers to a service in which configuration of a communication device, including installation and setting of the generative information processing application program, is performed or assisted from a location different from a location of the communication device by use of a management terminal and the server.

In one embodiment, a server, a terminal, and a user cooperate to implement a system that deploys and configures a generative AI model on a communication device while enforcing device-specific and user-specific privacy and usage constraints.

The server uses a hardware platform that includes at least one general-purpose processor, such as a multi-core central processing unit, system memory such as dynamic random access memory, nonvolatile storage such as a magnetic disk or a solid-state drive, and a network interface controller connected to a packet-switched network. The server executes an operating system such as a general-purpose server operating system and runs application software implemented in, for example, an interpreted or compiled language. The server further executes a web application framework and a data management system such as a relational database management system and, optionally, a key-value store for caching configuration data.

The terminal uses a hardware platform that includes an application processor, volatile memory, nonvolatile memory, a wireless communication module for wireless local area communication or cellular communication, a display device, and input devices such as a touch-sensitive panel and a microphone. The terminal executes a mobile operating system such as a smartphone operating system and supports an application distribution client for downloading and installing application programs from an application store.

The server maintains, in the database system, structured records representing terminal attribute information and user attribute information. The server stores the terminal attribute information in a table that includes fields such as a device identifier, a device type category, an operating-system version code, a hardware capability indicator (for example, a classification of memory size and processor performance), a supported language code, and a region code. The server stores the user attribute information in another table that includes fields such as a user identifier, an account type, a language preference code, a region code, and a privacy preference flag indicating an opt-in or opt-out state for acquisition of personal information.

The server maintains a configuration rule set in the database or in a rule repository. The configuration rule set associates combinations of terminal attribute information and user attribute information with configuration profiles. Each configuration profile includes parameters such as a target generative AI model identifier, an endpoint uniform resource locator for a model-serving API, a maximum length of a prompt sentence, default temperature and top-k sampling parameters for token generation, a default response language, and a default privacy control level. The server represents the configuration profiles using a structured data format such as a relational schema or a structured text format stored in the database.

The server further maintains an application catalog in the database. The application catalog associates device type categories and operating-system versions with application identifiers used in the application distribution infrastructure. Each record in the application catalog includes a package identifier, a minimum and maximum supported operating-system version, a region restriction flag, and a pointer to application acquisition information such as a download endpoint or store listing identifier.

The server also maintains help content metadata for instructional content. A help content table includes entries for video information and text information explaining a usage method of the generative AI model. Each entry stores a content identifier, a content type (video or text), a topic label such as “how to enter a prompt sentence,” “how to interpret a response,” or “how to set privacy options,” a supported language code, and a reference identification information field storing, for example, a network resource locator or another content index. The server acquires terminal attribute information and user attribute information from the terminal via a network interface. The server receives a structured data object in a request body, parses the data, verifies field types and value ranges, and stores or updates corresponding records in the terminal attribute table and user attribute table. The server then queries the configuration rule set using the terminal attribute information and the user attribute information as lookup keys. The server executes a deterministic selection algorithm that selects a configuration profile with maximum compatibility and priority. The server generates configuration information processing commands by instantiating a configuration command template with values from the selected configuration profile and from the user attribute information.

The server represents the configuration information processing commands as a hierarchical data structure that includes sections for application acquisition, connection setting, privacy control, and instructional content association. The application acquisition section contains application program acquisition information such as package identifiers and distribution endpoints. The connection setting section contains parameters used by the terminal to configure network access to the generative AI model, including the endpoint uniform resource locator, authentication parameter templates, timeout values, and retry strategies. The privacy control section contains privacy control information indicating permission or prohibition of storage of usage history information and prompt sentence information. The instructional content association section contains reference identification information for instructional videos and texts selected according to the terminal attribute information and the user attribute information.

The server applies a digital signature or message authentication code to the configuration information processing commands to ensure integrity and authenticity. The server transmits the configuration information processing commands to the terminal over a secure communication channel.

The terminal receives the configuration information processing commands, verifies the integrity using the digital signature or message authentication code, and stores the commands in a local configuration storage such as a file system or a lightweight database. The terminal invokes a configuration execution program that interprets the configuration information processing commands. The configuration execution program is implemented as an application or a module that receives the hierarchical data structure, parses each section, and interacts with the operating system and local data stores via application programming interfaces.

The terminal uses the application acquisition section to determine whether the generative information processing application program is already installed and whether its version satisfies a version condition. If installation or update is required, the terminal passes the package identifier and store endpoint to the application distribution client. The application distribution client establishes a connection to the application distribution infrastructure using the wireless communication module, downloads the application package, verifies its signature, and registers the application with the operating system. The terminal then stores a record of installation status and application version in local storage.

The terminal uses the connection setting section to set up network communication for the generative AI model. The terminal writes endpoint uniform resource locators, access-token placeholders, timeout settings, and retry parameters into application-specific preference storage such as a key-value store or a structured file. The terminal configures network libraries within the generative information processing application program to use these parameters when creating outbound requests to the generative AI model.

The terminal uses the privacy control section to control local data handling. If the privacy control information prohibits storage of usage history information and prompt sentence information, the terminal configures the generative information processing application program to avoid persisting prompt sentences and responses in local databases and caches, except for transient display buffers. If the privacy control information allows anonymized storage, the terminal configures the program to strip direct identifiers such as user identifiers and device identifiers before storing records. The terminal persists these privacy rules in local preference storage, so that subsequent program executions use the same constraints without re-querying the server.

The terminal uses the instructional content association section to retrieve instructional content. The terminal resolves reference identification information such as a network resource locator to a content resource, and then configures a help interface that displays a list of instructional entries. When the user opens a help screen, the terminal displays text content and plays video content explaining, for example, how to input a prompt sentence and how to adjust privacy settings.

The user operates the terminal to access the generative information processing application program. The user activates the application icon, and the application loads the configuration set by the configuration execution program. The user views a home interface that includes a text input element for a prompt sentence and, optionally, controls for voice input. The user can open a support screen that displays guidance for constructing an effective prompt sentence. The guidance may include examples such as:

“Tell me today's weather in Tokyo in simple English.”

“Summarize the main news headlines about global markets from today.”

“Generate a polite email in English asking my colleague to move our meeting from Tuesday to Thursday.”

“Explain in easy terms how this generative AI assistant protects my personal data.” “Write a short email to my manager explaining that I will be 30 minutes late.” “Summarize the key points from this article about climate change.”

“Explain in simple terms how this generative AI model works.”

The user enters a prompt sentence using the text input element or by speaking into the microphone. When voice input is used, the terminal uses a speech recognition module that processes the audio waveform, performs feature extraction such as mel-frequency cepstral coefficient computation, and decodes text using an acoustic model and language model. The resulting text is displayed and can be edited by the user.

The terminal constructs a request payload including the prompt sentence, a language code, a model identifier, and flags derived from the privacy control information. The terminal transmits this payload from the terminal to the server over an encrypted connection.

The server receives the request payload and extracts the prompt sentence information and associated metadata. The server consults the privacy control information previously stored for the user to determine whether logs and training datasets may include the prompt sentence and the response. The server then dispatches the prompt sentence to a generative information processing model.

In one embodiment, the generative information processing model is implemented as a neural network model having a transformer architecture. The server stores trained model parameters on a high-throughput storage device and loads relevant portions of the parameters into main memory and an accelerator memory associated with a graphics processing unit. The transformer network includes an embedding layer that maps discrete token identifiers to continuous vectors, multiple encoder-decoder or decoder-only layers each consisting of multi-head self-attention sublayers and feed-forward sublayers, and a final linear projection layer that outputs logits for the next token. Each self-attention sublayer computes attention scores using scaled dot-products between query and key vectors, applies a softmax operation to derive attention weights, and obtains context vectors as a weighted sum of value vectors. The feed-forward sublayer uses two linear transformations separated by a nonlinear activation function such as rectified linear units or gated activation functions. The server tokenizes the prompt sentence using a subword tokenization algorithm such as byte-pair encoding. The server converts the token sequence into an integer sequence, passes it through the embedding layer and the transformer layers, and iteratively generates output tokens using a sampling strategy such as top-k or nucleus sampling, controlled by temperature and other parameters contained in the configuration profile. The server applies a content-safety filter implemented as a classifier neural network or as a rule-based post-processor to remove or modify disallowed segments of the generated sequence. The server assembles the remaining tokens into a textual response string.

The server constructs a response payload that includes the generated response information and, optionally, suggested follow-up prompt candidates derived from representations in intermediate layers of the transformer network or generated by a secondary suggestion model. The server optionally records the prompt sentence and response into a usage history database if the privacy control information allows storing such records. If the privacy control information prohibits storage, the server discards the prompt sentence and response after responding.

The terminal receives the response payload, parses the structured data, and renders the generated response, for example in a conversational interface. The terminal updates any local history view according to the privacy control information; for example, if local storage is permitted, the terminal inserts new entries into a local history table stored in a lightweight database. If local storage is forbidden, the terminal avoids writing such data to nonvolatile memory and maintains the content only in volatile memory for display.

The terminal and the server cooperate to update settings over time. When the user opens a settings screen and changes privacy preferences or connection options, the terminal writes the changed values to local storage and sends setting change information to the server. The server updates the privacy control information and configuration profile associated with the user, and in some cases updates the access conditions to the generative information processing model, such as throttling the number of requests or modifying allowed content types. The server or the terminal may then regenerate configuration information processing commands to reflect new constraints.

In another embodiment, a management terminal participates in a remote configuration support service. The management terminal connects to the server, acquires terminal attribute information and user attribute information for a plurality of communication devices, and receives configuration information processing commands and application program acquisition information for each device. The management terminal relays the configuration information processing commands to each communication device over a local network or via a remote device management protocol. In this embodiment, the management terminal reduces duplication of configuration logic by acting as a relay, while the server remains the origin of configuration decisions and privacy policies.

The described configuration mechanism yields technical effects that go beyond mere automation of human tasks. The server generates a single, consistent configuration information processing command object that encodes application acquisition, connection settings, privacy controls, and instructional content selection. Because the terminal interprets this object through a configuration execution program, the terminal avoids executing redundant discovery and negotiation procedures with multiple independent services. Consequently, the number of network round-trips and the amount of configuration data transmitted between the terminal and the server are reduced. This reduction in repeated configuration protocols and separate privacy negotiation leads to decreased network bandwidth consumption and faster availability of the generative AI model for user interaction.

Furthermore, the tight coupling of privacy control information with the generative AI model execution environment produces a concrete improvement in data management within computer infrastructure. Instead of post-hoc filtering of large log files, the server enforces privacy constraints at the point where the model output is generated, using explicit privacy flags to determine whether to write entries to storage. This significantly reduces the volume of data maintained in memory and in persistent storage, improving cache hit rates and lowering storage I/O overhead. By limiting data capture at the source based on structured privacy rules, the system decreases the computational complexity of downstream analytics and model training pipelines.

The described use of configuration profiles also improves computational efficiency of the generative AI model. By choosing model identifiers and maximum sequence length parameters based on terminal capabilities and user needs, the server avoids invoking unnecessarily large models or excessive token lengths for resource-constrained terminals. This adaptive profiling reduces the number of floating-point operations per request on the server's accelerator hardware, leading to lower latency and improved throughput under high load.

The generative AI model operates under rules that differ from conventional human workflows. The model internally encodes statistical relationships between tokens across a large corpus and uses attention mechanisms to assign dynamic contextual weights to different parts of the prompt sentence. The selection of next tokens is governed by probability distributions computed from learned weights, and the sampling algorithm applies non-intuitive strategies such as excluding low-probability mass or restricting output diversity through top-k constraints. These rules and strategies are not mere codifications of human decision trees but are emergent from gradient-based optimization over high-dimensional parameter spaces.

The model is trained using supervised learning and, optionally, reinforcement-learning fine-tuning. During supervised learning, the server iteratively processes batches of token sequences, computes model outputs, and evaluates an error function such as cross-entropy loss between predicted token distributions and ground-truth next tokens. The server updates weights using an optimization method such as stochastic gradient descent with momentum or adaptive methods. During fine-tuning, the server may use reward signals representing response quality to adjust model behavior through policy gradient methods. The training procedure uses data augmentation techniques such as random truncation of contexts, paraphrasing of prompts, and masking of identifiers to increase robustness and reduce overfitting.

Because the system enforces configuration and privacy controls via structured commands and integrated model access policies, the server can dynamically adjust the behavior of the generative AI model without modifying application code on the terminal. For example, when a new regulation requires additional constraints on logging of prompt sentences in a particular region, the server updates the privacy control information and configuration profile for that region, such that the model-serving layer immediately respects the new constraints. This architecture localizes changes to server-side configuration data and avoids distributing new application binaries to a large population of terminals, which contributes to system scalability and reliability.

Alternative embodiments may use different model architectures, such as encoder-only or encoder-decoder networks, or may employ specialized submodels for classification and content filtering. Alternative embodiments may also use different application distribution infrastructures, different network protocols, or different formats for configuration information processing commands, such as binary serialization formats or domain-specific configuration languages, as long as the server continues to generate unified configuration commands that control application acquisition, connection parameters, privacy behavior, and instructional content association. In all such embodiments, the server, the terminal, and the user cooperate in a manner that yields improvements in processing efficiency, storage management, and privacy enforcement when operating a generative AI model that processes prompt sentences on a communication device.

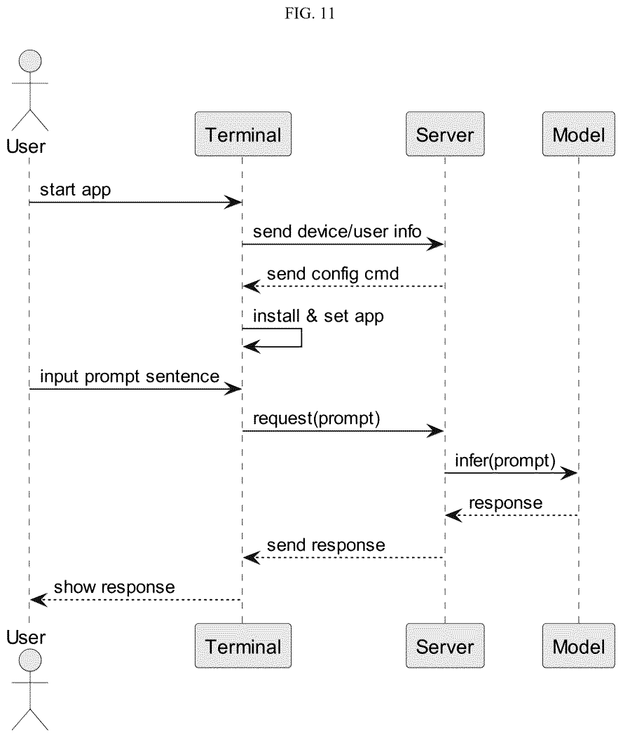

The following describes the processing flow using FIG. 11.

### Step 1:

The terminal transmits terminal attribute information and user attribute information to the server.

The terminal collects input data including a device identifier, device type, operating system version, available memory, language setting, region setting, user identifier, user language preference, and a privacy preference flag. The terminal packages these values into a structured request payload and sends the payload to the server over a secure communication channel. As data processing, the terminal reads system properties via an operating system API, reads stored user preferences from local storage, and encodes the values into a structured format. The output of this step is a network request containing the terminal attribute information and the user attribute information delivered to the server.

### Step 2:

The server determines a configuration profile based on the received terminal attribute information and user attribute information.

The server receives the request payload as input and parses the structured data into internal objects. The server queries a configuration rule set in a database using keys such as device type, operating system version, region, and account type. The server then performs data processing that includes rule evaluation, priority resolution, and compatibility checking to select one configuration profile. The server computes a result that includes selection of a generative AI model identifier, a model endpoint address, a maximum prompt sentence length, default generation parameters, a default response language, and a default privacy level. The output of this step is a selected configuration profile object in server memory.

### Step 3:

The server generates configuration information processing commands.

The server uses as input the selected configuration profile, the terminal attribute information, and the user attribute information. The server loads a configuration command template and replaces placeholder fields with actual values from the profile and attribute information. As data processing, the server constructs a hierarchical data structure with sections for application acquisition, connection settings, privacy control, and instructional content references. The server serializes this structure into a transferable format and applies a digital signature or message authentication code. The output of this step is a signed configuration information processing command payload ready to be sent to the terminal.

### Step 4:

The server generates application program acquisition information and associates it with the configuration information processing commands.

The server takes as input the terminal attribute information and an application catalog stored in a database. The server searches the catalog using conditions such as device type, operating system version, and region code, and selects an appropriate generative information processing application program. The server extracts a package identifier, a distribution endpoint, and version constraints, and embeds these values into the application acquisition section of the configuration commands. The server performs data processing that links the selected application record with the configuration profile and replaces template fields in the command structure. The output of this step is an updated configuration command payload that includes application program acquisition information.

### Step 5:

The server generates privacy control information based on the user attribute information. The server uses as input the privacy preference flag from the user attribute information and any region-specific policy rules stored in a privacy policy table. The server evaluates these inputs to compute a set of privacy control parameters, including permission or prohibition of storage of usage history information, permission or prohibition of storage of prompt sentence information, and a mode for anonymization. As data processing, the server maps user preferences and regulatory constraints to concrete boolean flags and policy codes, then injects these values into the privacy control section of the configuration commands and into a user privacy record. The output of this step is updated privacy control information bound to the user and embedded in the configuration commands.

### Step 6:

The server selects instructional content and attaches reference identification information.

The server takes as input the terminal attribute information, the user attribute information, and a help content metadata table. The server filters help content entries by language code, device type, and topic relevance, such as “how to enter a prompt sentence” and “how to set privacy options.” The server then performs data processing to rank or prioritize content, and selects one or more content identifiers. The server embeds corresponding reference identification information, such as resource locators, into the instructional content section of the configuration commands. The output of this step is a configuration command payload that includes links to appropriate instructional video information and text information.

### Step 7:

The server transmits the configuration information processing commands to the terminal.

The server uses the fully populated configuration command payload as input and sends it to the terminal via a secure communication protocol. The server may log the transmission event with a timestamp and device identifier. The main data operation is the encapsulation of the payload into a network response message and the maintenance of a record that associates the configuration command identifier with the device and user. The output of this step is reception of the configuration commands by the terminal.

### Step 8:

The terminal verifies and stores the configuration information processing commands.

The terminal receives the configuration command payload as input and verifies the digital signature or message authentication code using stored verification data. The terminal parses the hierarchical structure into internal data objects and checks for version compatibility. As data processing, the terminal validates required fields, converts serialized values into native data types, and stores the command content in local configuration storage such as files or a local database. The output of this step is a locally stored configuration command representation ready for execution by the configuration execution program.

### Step 9:

The terminal acquires and installs the generative information processing application program.

The terminal uses as input the application acquisition section of the configuration commands, including a package identifier and distribution endpoint. The terminal invokes an application distribution client that contacts the application distribution infrastructure, sends a request including the package identifier, and downloads the application package over a network connection. The terminal verifies the package signature and checks version conditions against local operating system information. As data processing, the terminal unpacks the package, registers the application with the operating system, and allocates local storage for the application. The output of this step is an installed generative information processing application program on the communication device.

### Step 10:

The terminal executes the configuration execution program and applies connection settings.

The terminal uses as input the parsed configuration commands and local system properties such as language, region, and network configuration. The configuration execution program reads the connection setting section and writes endpoint addresses, authentication parameter placeholders, timeout values, and retry parameters into the application's preference storage or configuration files. The terminal uses operating system APIs to store these values in a persistent key-value store or structured file. The data processing includes mapping generic endpoint templates to concrete endpoints and preparing placeholder slots for tokens. The output of this step is a generative information processing application program configured to communicate with the generative AI model endpoint.

### Step 11:

The terminal applies privacy control information to local storage and user interface behavior.

The terminal uses as input the privacy control section of the configuration commands. The terminal writes privacy flags and policy codes into a dedicated preference area and configures application components to honor these values. As data processing, the terminal updates logging modules to disable or restrict writing of prompt sentences and responses to persistent storage, and configures history views to either display session-only records or include stored records depending on the policy. The output of this step is a local environment where storage of usage history information and prompt sentence information behaves according to the privacy control information.

### Step 12:

The terminal prepares and links instructional content for display.

The terminal uses as input the instructional content section, including reference identification information for video and text content. The terminal resolves each identifier to a content resource, either by local lookup or by issuing network requests to a content server. The terminal builds a help index that associates topics such as “how to enter a prompt sentence” with the retrieved resources. As data processing, the terminal updates user interface elements to show help entries, and preloads thumbnails or text snippets. The output of this step is a help interface on the terminal that is ready to display instructional video information and text information.

### Step 13:

The user starts the generative information processing application program and accesses the support screen.

The user provides input by tapping the application icon or selecting it from an application list. The terminal launches the application and reads stored configuration and privacy parameters. The user may then open a support screen, which the terminal populates with instructional text and video links based on the help index generated earlier. The terminal performs data processing to assemble localized strings and media resources into a user interface layout. The output of this step is a displayed application home screen and support screen that reflect the configured model endpoint, language, and privacy behavior.

### Step 14:

The user inputs a prompt sentence and submits a request.

The user uses the text input area or a voice input control to enter a prompt sentence, such as “Tell me today's weather in Tokyo in simple English,” “Summarize the main news headlines about global markets from today,” or “Explain in simple terms how this generative AI model works.” The terminal collects the user input as raw text or as audio, applies speech recognition and text normalization as needed, and displays the final prompt sentence for confirmation. As data processing, the terminal constructs a request payload that includes the prompt sentence, language code, model identifier, and privacy flags. The output of this step is a structured processing request ready to be transmitted to the server.

### Step 15:

The terminal transmits the processing request including the prompt sentence to the server. The terminal uses the constructed request payload as input and sends it to the model endpoint specified in the configuration settings using a secure network protocol. The terminal adds authentication information and device identifiers where permitted by the privacy control information. The data processing includes serialization of the request data and encryption by the communication stack. The output of this step is a network message received by the server that contains the prompt sentence information and related metadata.

### Step 16:

The server determines processing conditions for the generative AI model based on the prompt sentence and privacy control information.

The server receives the request payload, extracts the prompt sentence, user identifier, and privacy flags as input, and retrieves the corresponding privacy control information and configuration profile from its database. The server evaluates these inputs to select a generative AI model variant, decide on maximum token length, and determine whether logs and training data may include this request. As data processing, the server maps the configuration profile and privacy flags to model parameters such as temperature and sampling strategy, and constructs an internal inference configuration object. The output of this step is an inference configuration and an authorization decision for logging and storage.

### Step 17:

The server executes response information generation processing using the generative AI model.

The server uses as input the prompt sentence and the inference configuration. The server tokenizes the prompt sentence into tokens, feeds the token sequence into a trained transformer-based generative AI model, and iteratively generates output tokens using the configured sampling method. The server then converts the generated token sequence back into a text string. As data processing, the server performs vector operations, attention weight computations, nonlinear transformations, and probability sampling as defined by the model architecture and learned parameters. The output of this step is generated response information corresponding to the prompt sentence.

### Step 18:

The server applies privacy control and constructs a response payload.

The server uses as input the generated response information, the prompt sentence, and the privacy control information. If storage is permitted, the server writes a record containing the prompt sentence, response, and metadata into a usage history database; if anonymized storage is required, the server removes direct identifiers before storing; if storage is prohibited, the server discards the content after building the response payload. As data processing, the server formats the response string and optional follow-up suggestions into a structured response object. The output of this step is a response payload ready to be transmitted back to the terminal.

### Step 19:

The terminal receives the response payload and displays the generated response. The terminal uses the response payload as input, parses the structured data, and extracts the response text and any suggested follow-up prompts. The terminal updates the user interface to display the response in a conversation view or document view. As data processing, the terminal may insert the response into a local session history in volatile memory, and, if local storage is allowed by the privacy control information, also store it in a local database. The output of this step is a visible response shown to the user and, optionally, updated local history data.

### Step 20:

The user evaluates the response and optionally updates settings or issues another prompt sentence.

The user provides input by reading the displayed response and deciding whether it is satisfactory. The user may enter another prompt sentence, refine the previous one, or open the settings screen to adjust privacy options and notification preferences. The terminal reacts by capturing new input, updating local settings, and, when settings are changed, sending setting change information to the server. As data processing, the terminal modifies stored configuration values and may purge or retain local history according to new privacy settings.

The output of this step is either a new processing request cycle or an updated configuration state that affects subsequent interactions with the generative AI model.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional techniques for deploying and configuring applications that utilize a generative AI model on a user communication terminal rely heavily on manual operations performed by end users or sales staff. In particular, installation of an application program, preparation and transfer of configuration files, and adjustment of privacy-related options such as opt-out settings for acquisition of personal information are typically carried out through multiple separate user interfaces and wizards on the communication terminal. This fragmented workflow increases the probability of configuration errors, inconsistent privacy settings, and security vulnerabilities, and results in a prolonged time period before the generative AI model can be reliably used on the communication terminal.

Moreover, existing systems do not provide an integrated mechanism by which a central processor can verify, based on machine-readable operation log information, that configuration information has been correctly applied on the communication terminal and that the connection state to a generative AI model satisfies predetermined conditions. As a result, even when installation and configuration appear to be complete, the communication terminal may silently operate with incorrect connection parameters, invalid authentication information, or unintended collection of personal information, which degrades system reliability and creates compliance risks.

In addition, conventional guidance for end users on how to construct an effective prompt sentence for a generative AI model is generally static and not linked to the actual system state, user attributes, or user emotional state. While tutorial videos or help pages may exist, they are not dynamically tailored to the particular configuration, history, or emotional context of the user, and they are not automatically triggered by the completion of installation and configuration steps. Consequently, users without specialized technical knowledge face difficulty in understanding how to safely and efficiently interact with the generative AI model, which limits utilization of the underlying computing resources and reduces the practical value of the technology.

Furthermore, in retail or service locations that provide configuration proxy services for communication terminals, there is no standardized computer-implemented workflow that integrates remote application deployment, configuration file transfer, verification based on operation logs, and generation of prompt sentences that guide operators and users through the process. This lack of integration prevents systematic automation, hinders scalability across many devices, and fails to leverage the capabilities of modern information processing equipment to reduce human error.

Accordingly, there is a need in the computing field for an improved system and method that centrally orchestrate, by means of a processor, (i) identification of a communication terminal and automated transfer and installation of a generative AI application, (ii) generation and deployment of structured configuration information including personal information opt-out settings, (iii) verification of correct application of such configuration via log analysis, and (iv) generation and delivery of tailored prompt sentences and visual guidance for interaction with a generative AI model. Such a system should improve reliability, security, and usability of generative AI services on communication terminals, while reducing manual intervention and enabling scalable deployment in diverse environments including retail and service locations.

The specific processing by the specific processing unit 290 of the data processing device 12 in Application Example 1 is realized by the following means.

The present invention provides a server comprising a processor configured to identify a communication terminal based on terminal identification information acquired from a user by using an external connection interface, to transfer an application program that enables utilization of a generative AI model to the communication terminal, and to automatically execute an installation process of the application program on the communication terminal; to generate configuration information in a structured data format by referring to user attribute information and personal information handling policy information stored in a storage device, the configuration information including connection information to a generative AI model, authentication information, language settings, and an opt-out setting for acquisition of personal information, and to transfer a configuration file including the configuration information to a predetermined area in the communication terminal; to transmit a start instruction to a generative AI application installed on the communication terminal, to acquire operation log information from the generative AI application, and to analyze the operation log information to verify that the configuration file has been correctly read, that a connection state to the generative AI model satisfies a predetermined condition, and that the opt-out setting for acquisition of personal information satisfies the predetermined condition; to transmit notification information to the communication terminal, the notification information including reference information to visual information data that explains a usage method of the generative AI application on the communication terminal, and to generate explanation information in the visual information data that presents a method and precautions for creating a prompt sentence to be input to the generative AI model; and to generate prompt sentences for performing proxy configuration of the communication terminal and enabling utilization of the generative AI model, for confirming an opt-out setting regarding acquisition of personal information and automatically executing a required procedure related to the opt-out setting, and for recognizing a user emotion, analyzing the user emotion, and adjusting dialogue content and response style of the generative AI model based on an analysis result of the user emotion. This enables computer-implemented automation and verification of installation and configuration of a generative AI application across communication terminals, improves the reliability and security of connections to the generative AI model including enforcement of personal information opt-out settings, and provides dynamically tailored guidance and prompt sentence generation that enhance user interaction efficiency and usability while reducing manual configuration burden in both individual and service-location deployment scenarios.

The term “system” refers to an assembly of one or more information processing apparatuses, communication terminals, storage apparatuses, and communication interfaces that cooperate to perform installation, configuration, verification, and guidance processes related to a generative AI model.

The term “server” refers to an information processing apparatus or group of apparatuses that include at least one processor and a storage apparatus, and that execute control logic for remote installation, configuration, verification, and guidance operations with respect to communication terminals.

The term “processor” refers to a hardware computation element, such as a central processing unit or other processing circuitry, that executes instructions stored in a storage apparatus to perform information processing operations specified in the claims.

The term “communication terminal” refers to an electronic apparatus used by a user, such as a portable computing device or other network-capable device, that is configured to execute an application utilizing a generative AI model and to present information to the user. The term “terminal identification information” refers to information that uniquely or quasi-uniquely identifies a communication terminal, such as an identifier assigned by an operating system, a hardware identifier, or an externally managed device identifier.

The term “external connection interface” refers to a hardware and software interface that enables the server to communicate with the communication terminal, such as a wired or wireless communication interface and an associated command or protocol layer.

The term “application program” refers to executable code and associated resources that, when installed on a communication terminal, enable the communication terminal to interact with a generative AI model.

The term “installation process” refers to a sequence of operations performed on a communication terminal to store an application program in an appropriate storage region, register the application program with an operating system, and prepare the application program for execution.

The term “generative AI application” refers to an application program installed on a communication terminal that is configured to transmit prompt sentences or other input data to a generative AI model and to receive output data generated by the generative AI model. The term “generative AI model” refers to an artificial intelligence model that generates information such as text, image, audio, or other content in response to input data including a prompt sentence or context information.

The term “user attribute information” refers to information related to a user, such as language preference, region, usage preference, or account attribute, that is stored in a storage apparatus and used to generate configuration information.

The term “personal information handling policy information” refers to information indicating rules or preferences for processing, collecting, storing, or transmitting personal information of a user, including opt-out settings for acquisition of personal information.

The term “configuration information” refers to information that defines operational parameters of a generative AI application or a generative AI model, including but not limited to connection information, authentication information, language settings, and opt-out settings for acquisition of personal information.

The term “structured data format” refers to a machine-readable representation of data in which elements are organized according to a defined structure, such as a key-value format, hierarchical format, or table format, enabling reliable parsing and processing by a program. The term “configuration file” refers to a file stored in the communication terminal that includes configuration information in a structured data format and that is read by the generative AI application to determine its runtime behavior.

The term “predetermined area” refers to a storage region or path within a storage apparatus of a communication terminal that is designated for storing a configuration file or related data and that is accessible to the generative AI application.

The term “start instruction” refers to a command or signal transmitted from the server to the communication terminal to initiate execution of a generative AI application or a particular component thereof.

The term “operation log information” refers to information recorded by a communication terminal or a generative AI application that indicates events, states, errors, or other operational data during execution of the application.

The term “predetermined condition” refers to a threshold or rule defined in advance by system design, configuration policy, or program logic, which is used to determine whether a connection state or setting is acceptable.

The term “opt-out setting for acquisition of personal information” refers to a setting that instructs a system not to collect, store, or transmit certain categories of personal information of a user, or to limit such collection according to a defined policy.

The term “notification information” refers to information transmitted from the server to the communication terminal to inform a user regarding the state of installation, configuration, availability of guidance content, or other system status.

The term “visual information data” refers to video data, image data, graphical content, or a combination thereof that is capable of visually presenting explanatory information to a user on a display apparatus.

The term “reference information” refers to information such as a locator, address, identifier, or metadata that enables a communication terminal to access or retrieve visual information data or other resources.

The term “usage method” refers to a procedure or set of instructions that describe how a user operates a generative AI application or interacts with a generative AI model.

The term “prompt sentence” refers to a natural language expression or other input statement supplied by a user or by the server to a generative AI model to request generation of content or performance of a task.

The term “explanation information” refers to information contained in visual information data or other guidance content that describes, instructs, or warns a user regarding operations, such as how to create, refine, or evaluate a prompt sentence.

The term “proxy configuration” refers to a process in which the server performs, on behalf of the user, configuration operations for a communication terminal or generative AI application, without requiring the user to manually execute those operations on the terminal.

The term “authentication information” refers to data used to authenticate a user, a device, or an application to a service that provides access to a generative AI model, such as tokens, keys, credentials, or identifiers.

The term “language settings” refers to configuration parameters that specify a display language, input language, or output language to be used by a generative AI application or a generative AI model.

The term “user emotion” refers to an estimated emotional state of a user, such as satisfaction, frustration, confusion, or engagement, as inferred from input data, behavior, or biometric signals.

The term “dialogue content” refers to the semantic and structural substance of messages exchanged between a user and a generative AI model, including questions, responses, and follow-up prompts.

The term “response style” refers to characteristics of output generated by a generative AI model, such as tone, politeness level, level of detail, length, or formality.

The term “usage history” refers to data indicating past interactions of a user with a generative AI application or a communication terminal, including prior prompt sentences, generated outputs, and operation events.

The term “prompt sentence input status” refers to information indicating current or recent input behavior related to prompt sentences, such as frequency, type, length, or difficulty of prompt sentences entered by a user.

The term “sales location” refers to a commercial site or facility where communication terminals are offered or prepared for users, and at which configuration proxy services may be provided.

The term “service location” refers to a facility or site that provides support, maintenance, or configuration services for communication terminals or associated applications.

The term “configuration proxy service” refers to a service in which personnel or automated systems at a sales location or service location perform, on behalf of a user, configuration and deployment operations for applications and settings on a communication terminal. The term “information processing apparatus installed at the sales location or the service location” refers to one or more computing devices deployed at such locations that execute server-side logic for remote installation, configuration, and verification.

The term “progress state” refers to information indicating a current stage, completion level, or status of an installation process, configuration file transfer process, or verification process. The term “result of the processes” refers to an outcome of installation, configuration, or verification operations, including success, failure, partial completion, or error conditions.

In one embodiment, a server, a terminal, and a user cooperate to implement the invention.

The server includes a processor, a main memory, a nonvolatile storage device, and a network interface. The server executes an operating system such as a general-purpose server operating system and executes application programs including a deployment control module, a configuration generation module, a log analysis module, a privacy control module, and a guidance generation module. The server further includes an external connection interface to the terminal, for example a wired or wireless debugging or device-management interface. In one concrete implementation, the server executes a Python runtime, uses a command-line device bridge such as an Android debug bridge over a universal serial bus connection, and uses a relational database management system such as a structured query language database. The terminal includes a processor, a memory, a wireless communication interface, a storage device, and a display apparatus with a touch input interface. The terminal executes an operating system such as a mobile operating system and an application runtime environment. The terminal executes a generative AI application, which includes a user interface module, a network communication module, a configuration loader module, and a prompt management module. The terminal further maintains an operation log buffer integrated with a system log facility.

The user uses the terminal to access a generative AI model. The user provides terminal identification information and preferences, including language preferences and personal-information opt-out preferences, to the server via a network-accessible interface or via an operator at a sales or service location.

The server generates a program configuration by processing structured data in the database.

The server uses the processor to read user attribute information, personal information handling policy information, and system defaults stored in the database. The server converts this data into a structured configuration object that contains fields such as an application endpoint uniform resource locator for a generative AI model gateway, an authentication token, a language code, a flag indicating an opt-out setting for acquisition of personal information, and a set of default prompt sentence examples. The server serializes this configuration object into a configuration file and stores it in a local directory in a machine-readable format.

The server uses the external connection interface to control the terminal as a physical device.

The server transmits an application package that contains the generative AI application to the terminal and invokes an installation routine on the terminal. In one embodiment, the server issues installation commands and receives responses that include status codes and text messages. The server parses these messages and determines whether the installation routine has successfully written the application binaries into the terminal's internal storage and has registered the application with the terminal's operating system. Because the server interacts at the level of device-control commands and parses structured responses, the server performs more than mere abstract data processing; the server actively controls a physical computing device to change its installed software state.

The server transmits the configuration file to a predetermined area in the terminal's storage. The server designates a directory in a shared or application-specific storage area and writes the configuration file into this directory. The terminal later opens and parses this configuration file using the configuration loader module. In this way, the server and terminal jointly implement a concrete data path where configuration information flows from centralized storage through the external connection interface into a specific storage location on the terminal, and this data path is not limited to abstract business logic.

The server then initiates verification operations that improve the reliability of the computing system. The server instructs the terminal to start the generative AI application. After the application starts, the terminal records event information, configuration load results, and connection attempts to the generative AI model gateway into the operation log. The server uses the log analysis module to retrieve this operation log information via the external connection interface or via the network. The server parses the log entries by applying pattern-matching rules, regular expressions, and state-machine logic to detect messages that indicate success or failure. For example, the server searches for markers such as “Configuration load success,” “Configuration parse error,” “Connection established,” and “Authentication failed.”

The server uses these log entries to compute a verification result that indicates whether the configuration file has been correctly read and whether a connection to the generative AI model has been established under the expected security parameters. Because the server uses systematic parsing rules and state evaluation logic, the server improves the accuracy and speed of detecting misconfigurations compared with manual inspection by a human operator. The server can further reduce the amount of data transferred during verification by requesting only log segments that match specific tags or time ranges, thereby reducing communication load and improving overall system performance.

The server manages privacy-related data fields in a technically structured manner. The privacy control module in the server encodes opt-out settings as explicit fields in the configuration object and enforces them within the generative AI application and within the generative AI model gateway. For instance, the configuration file can include a field that indicates that personally identifiable text shall not be persisted beyond a defined retention period or shall not be used in training datasets. When the terminal sends a prompt sentence to the generative AI model, the terminal includes a metadata flag derived from this configuration. The generative AI model gateway, which also runs on one or more processors, inspects this metadata flag and routes the input and output to a restricted processing path that disables logging of raw text payloads. This mechanism provides a machine-enforceable privacy constraint that is applied consistently across devices and sessions, and is not simply a user-interface checkbox without actual enforcement logic.

The generative AI model itself resides on one or more model servers. In one embodiment, the generative AI model is a transformer-based neural network with multiple attention layers, feedforward layers, and layer-normalization components. The model receives tokenized prompt sentences as input. The model architecture includes an embedding layer that converts tokens into dense vectors, a stack of self-attention blocks that compute attention weights over previous tokens, and an output projection layer that yields probability distributions over the next token. The model has been trained on preprocessed text corpora using a supervised learning objective and a next-token prediction objective. The model parameters, including weight matrices in the attention and feedforward layers, have been optimized using a stochastic gradient descent variant such as Adam, with a cross-entropy loss function as an error function. During training, the system has used regularization techniques such as dropout and weight decay to improve generalization.

The server maintains a model gateway that applies additional rule-based processing to prompt sentences. The model gateway enforces constraints that are not typically applied in human workflows. For example, the model gateway splits a prompt sentence into syntactic and semantic segments using a natural language parser, computes a complexity score based on token length and syntactic depth, and applies a heuristic rule set that decides whether to augment the prompt with clarifying context. If the complexity score falls below a threshold, the server supplements the prompt with additional clarifying phrases, such as specifying output length limits or style preferences, before sending the prompt to the generative AI model. These rules are implemented as deterministic control logic rather than as simple template reuse. As a result, the system adjusts prompts in a consistent, machine-optimized manner that improves the quality and predictability of model outputs, rather than relying on ad hoc user intuition alone.

The generative AI model gateway and the server cooperate to enhance efficiency and reduce error rates. The server caches frequently used default prompt patterns and their corresponding model responses in a data structure such as a key-value store. When the server recognizes that an incoming prompt sentence matches one of the default patterns within a defined similarity threshold, the server retrieves the cached result instead of sending the request to the model servers. Similarity can be computed using vector representations of prompt sentences produced by an auxiliary encoder network or by a statistical similarity metric over token sequences. This approach reduces computational load on the model servers, decreases response time for common requests, and lowers network bandwidth usage between the terminal and the model servers.

The terminal loads the configuration file at startup of the generative AI application. The configuration loader module parses the structured configuration information and initializes internal parameters of the network communication module and the user interface module. For example, the terminal sets the default language of the user interface and the default tone of generated responses according to the configuration. The terminal also configures the prompt management module with a list of sample prompt sentences. These sample prompt sentences can include, for example:

“Write a short and friendly email to invite my colleagues to a project kickoff meeting next Monday at 10 AM.”

“Summarize today's news in simple English.” “Generate three creative marketing slogans for a new eco-friendly water bottle.”

“Create a polite English email to inform my manager that I will be working from home tomorrow due to a medical appointment.”

“Generate three ideas for a social media post promoting a new smartphone with a high-resolution camera.”

The terminal displays these example prompt sentences in an on-screen help panel. The user can tap one of the examples to insert it into the prompt input field. This user interface behavior is realized through code in the generative AI application, which reads the examples from the configuration file and binds them to interactive user interface widgets. Because the examples originate from the centrally generated configuration file, the server can adjust them per user group or per deployment environment without manual updates on individual terminals.

The server generates prompt sentences not only for the generative AI model but also for internal guidance and control tasks. The guidance generation module uses a combination of rule-based text generation and pattern-based templates. For example, when the server detects a failure in the installation or configuration process, the server generates a diagnostic prompt sentence that describes the failure, the suspected cause, and suggested actions. These diagnostic prompt sentences can be used by an operator at a service location or fed into a support-oriented generative AI model that is specialized for troubleshooting. The server selects which template to use and which variable fields to fill based on the structured status data from the installation and verification components. This selection process uses explicit condition branches in the control logic and therefore can be audited and tested systematically. The server can further adapt guidance content to the estimated emotion of the user. In one embodiment, the terminal collects interaction features such as typing speed, error rate in prompt input, frequency of help panel usage, and dwell time on specific help sections. The terminal computes a feature vector and sends it to the server at intervals. The server runs a machine learning classifier, such as a shallow neural network or gradient-boosted decision tree, that has been trained to map such feature vectors to discrete emotion labels, for example “confused,” “frustrated,” or “confident.” The classifier uses a softmax output layer with a categorical cross-entropy loss function during training. The server selects or parameterizes guidance prompt sentences and visual information data according to the predicted emotion label, for example by increasing the level of detail or changing the tone to be more reassuring when the user appears confused. This mechanism does not merely mimic human support staff but implements a computable mapping from measurable interaction metrics to adaptive content selection, thereby improving the effectiveness and timeliness of guidance. The server provides visual information data, such as tutorial videos or interactive walkthroughs, that explain how to use the generative AI application and how to construct effective prompt sentences. The server stores this data on a content server and transmits reference information, such as a uniform resource locator or content identifier, to the terminal. The terminal, in turn, opens the reference using a browser module or embedded media player module. The server may generate subtitles and on-screen captions using an auxiliary generative model that is fine-tuned to produce concise instructional text. The use of structured metadata tied to specific sections of the tutorial video allows the server to link log events and user behavior to precise points in the content; for example, the server can instruct the terminal to start playback at the section that explains prompt refinement if the logs show repeated failed or low-quality prompts.

The described architecture improves computer technology in several concrete ways. First, the automated and verified installation process reduces the incidence of partially installed or misconfigured applications. By using explicit device-control commands, structured configuration files, and log-based verification, the server ensures that the terminal reaches a known-good configuration before the generative AI model is exposed to the user. This improves system reliability and reduces support incidents.

Second, the centralized generation and distribution of configuration information reduce redundant configuration effort and avoid divergence among terminals. Because the server stores configuration templates and user-specific data in structured form, the server can update and propagate changes at scale without manual edits on each device. This leads to more consistent enforcement of security policies and privacy constraints, and reduces the chance of human error.

Third, the integration of log analysis, emotion estimation, and guidance generation improves both computational efficiency and user experience. The server analyzes logs programmatically to detect failure conditions, which is faster and more accurate than manual inspection. The emotion classifier transforms complex user interaction patterns into actionable control signals that allow the system to adapt the type and intensity of guidance. These operations rely on specific algorithms, feature representations, and model structures rather than generic human decision making, and they thus represent a technical improvement to how computing systems manage user interactions.

Fourth, caching of common prompt-response pairs and conditional routing of requests to the generative AI model gateway reduce network traffic and decrease load on computational resources such as graphics processing units used for model inference. The system applies explicit similarity computations over vector representations of prompt sentences and uses threshold-based decisions to choose cached responses versus live model inference. This design achieves measurable gains in response time and resource utilization.

The invention is not limited to a single implementation. In an alternative embodiment, the external connection interface between the server and the terminal may be a mobile device management protocol over a wireless communication link instead of a debugging bridge. In another embodiment, the generative AI model may be an image generation model, in which case the prompt sentences describe desired images, and the configuration information includes resolution, color constraints, and content safety filters. In another variation, the emotion estimation module may use acoustic features from voice input when the terminal supports voice-based prompt entry. In each case, the server still generates configuration information, controls installation, performs verification, and produces prompt sentences and guidance content in accordance with the inventive concepts described above.

Through these cooperating hardware and software components, the server, the terminal, and the generative AI model jointly realize a technical solution that goes beyond simple automation of human tasks. The system modifies the internal operation of computing devices, optimizes data pathways, enforces machine-readable policies, and uses learned models and rule-based logic to manage configuration, privacy, and user guidance in a scalable and technically robust manner.

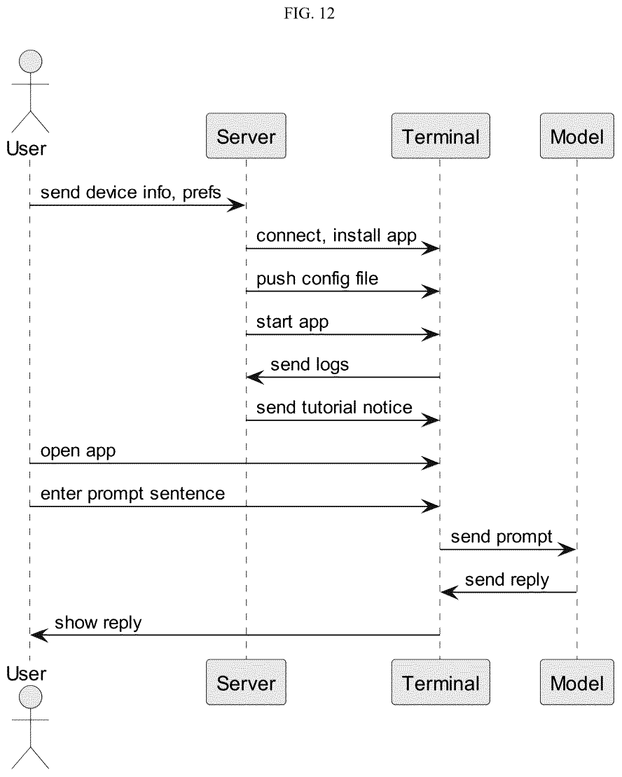

The following describes the processing flow using FIG. 12.

### Step 1:

The user provides terminal identification information and preference information. The user inputs a device identifier, language preference, and privacy preference (including an opt-out setting for acquisition of personal information) through a user interface provided by the server or an operator at a service location.

Input: raw user input values (device identifier string, language code, privacy flags).

Output: validated and normalized user profile data.

The server receives these values, checks the format of the device identifier, normalizes the language code to a standard representation, and encodes the privacy preference into a structured record stored in a database.

### Step 2:

The server records and manages user attribute information and personal information handling policy information. The server writes a new record into a database table, associating the device identifier with the user's language preference, authentication account identifier, and opt-out setting for personal information.

Input: validated and normalized user profile data from Step 1.

Output: stored user attribute record and policy record in the database.

The server executes database insert or update operations, and the server assigns an internal user key. The server thus prepares structured data later used for configuration generation.

### Step 3:

The server establishes a control connection to the terminal using an external connection interface. The server searches for the terminal by issuing a device-enumeration command that includes the device identifier and receives a list of connected devices.

Input: device identifier and control interface status.

Output: connection status and a handle for device control.

The server parses the command output, compares each device entry with the given device identifier, and selects the matching terminal. The server produces a device-control handle or session context for subsequent operations.

### Step 4:

The server verifies the readiness state of the terminal. The server sends a status inquiry command to the terminal to check whether an operating system boot process has completed and whether application installation is allowed.

Input: device-control handle from Step 3.

Output: terminal readiness flag and optional error code.

The server receives a return value, interprets the value as a Boolean or status code, and, based on the result, either proceeds or records an error. This data processing step consists of mapping low-level properties to a high-level readiness flag.

### Step 5:

The server transfers and installs the generative AI application on the terminal. The server locates an application package file in server storage and issues an installation command through the device-control handle, transmitting the application package to the terminal.

Input: application package file path and device-control handle.

Output: installation result status and installation log text.

The server streams the binary data of the application package to the terminal, then receives textual log messages describing success or failure. The server parses these messages, extracts keywords such as “Success” or “Failure,” and converts them into a structured status object.

### Step 6:

The server generates configuration information for the generative AI application. The server queries the database for user attribute information and personal information handling policy information associated with the device identifier. The server constructs a configuration object comprising fields such as a generative AI model gateway endpoint, an authentication token, a language setting, an opt-out flag, and a list of example prompt sentences.

Input: user attribute record and policy record from the database.

Output: configuration object in a structured internal representation.

The server applies data-processing operations such as field selection, value mapping, and default-value insertion to produce a complete configuration object that satisfies the schema expected by the terminal application.

### Step 7:

The server serializes the configuration object into a configuration file. The server converts the in-memory configuration object into a text representation and writes it to local server storage with a filename linked to the device identifier.

Input: configuration object from Step 6.

Output: configuration file stored at a specific file path.

The server orders and formats the fields, encodes strings using a chosen character encoding, and checks that all required fields are present. The server also logs the file path and checksum to verify integrity later.

### Step 8:

The server pushes the configuration file to the terminal. The server uses the device-control handle to send a file-transfer command specifying the local configuration file path and the destination directory on the terminal.

Input: configuration file path and device-control handle.

Output: file-transfer completion status and remote file metadata.

The server transmits the configuration file bytes, receives a completion message, and optionally issues a remote file-listing command. The server compares the reported file size and checksum with local values to confirm correct transfer.

### Step 9:

The server commands the terminal to launch the generative AI application. The server sends a start instruction through the device-control handle, specifying the application identifier and main entry point.

Input: application identifier and device-control handle.

Output: launch status and initial runtime log entries.

The server waits for a response indicating that the application has been started and then requests or subscribes to operation log information. The server stores the initial log entries for verification.

### Step 10:

The terminal loads and applies the configuration file. The terminal's configuration loader module opens the configuration file from the predetermined storage area and parses the structured content.

Input: configuration file as stored in terminal storage.

Output: internal configuration parameters for the generative AI application.

The terminal maps the fields to internal variables such as base uniform resource locator for the generative AI model, authentication header values, language code, and privacy flags. The terminal sets these variables in memory and initializes the network communication module and user interface module accordingly.

### Step 11:

The terminal generates operation log information for configuration loading and connection initialization. The terminal records events including “configuration file read attempt,” “configuration parse success or failure,” and “connection attempt to generative AI model gateway” into a log buffer.

Input: results of configuration parsing and initial connection operations.

Output: structured log entries with timestamps and status codes.

The terminal formats each event into a log line or log record with fields such as timestamp, component identifier, and result code, then writes these records into the system log facility.

### Step 12:

The server acquires and analyzes the operation log information from the terminal. The server issues a log-retrieval command and receives log text or structured log data.

Input: log data stream from the terminal and expected message patterns.

Output: verification result that indicates configuration and connection status. The server scans the log data using pattern-matching rules and parses the data into individual log records. The server then checks for presence or absence of success markers and error markers and computes Boolean results such as “configuration correct” and “connection established.” The server encapsulates these results in a structured verification report.

### Step 13:

The server updates the status of the terminal in the database based on the verification report. The server writes fields that indicate installation status, configuration status, and connection status into a management table associated with the device identifier.

Input: verification report from Step 12 and device identifier.

Output: updated deployment status record in the database.

The server executes database update statements and may also add an audit trail entry. By linking log-derived verification results to persistent status fields, the server maintains an accurate representation of each terminal's readiness state.

### Step 14:

The server generates notification information and guidance reference data. The server constructs a notification message that includes a reference to visual information data explaining how to use the generative AI application and how to construct a prompt sentence.

Input: deployment status record and content metadata for tutorial materials.

Output: notification payload containing message text and content reference (such as a uniform resource locator).

The server selects which tutorial or section to reference based on the user's language and possibly on error conditions discovered during verification, then assembles the payload.

### Step 15:

The server transmits the notification information to the terminal. The server uses a messaging or push-notification service to deliver the notification payload to the terminal.

Input: notification payload from Step 14 and terminal addressing information.

Output: delivery status and timestamp.

The server formats the payload into a protocol-specific message, sends it through the messaging service, and receives a response code indicating whether the message has been accepted and delivered.

### Step 16:

The terminal receives and displays the notification. The terminal's notification subsystem receives the incoming notification and presents a message such as “Your generative AI app is ready to use. Tap to watch the tutorial.” on the display.

Input: notification payload delivered from the server.

Output: on-screen notification and optional user interaction event.

The terminal decodes the payload, creates a visible notification element, and links the reference information to an action, such as launching a browser or an embedded media player to access the tutorial.

### Step 17:

The user starts the generative AI application. The user taps the application icon or the notification to launch the generative AI application on the terminal.

Input: user interaction event (tap or selection).

Output: active generative AI application user interface.

The terminal receives the event, passes it to the operating system launcher, and brings the generative AI application to the foreground. The application loads current configuration in memory and displays an input area for prompt sentences and a help area with example prompts.

### Step 18:

The user inputs a prompt sentence. The user types text such as “Write a short and friendly email to invite my colleagues to a project kickoff meeting next Monday at 10 AM.” into the prompt input field and optionally selects one of the example prompt sentences displayed on the screen.

Input: raw text entered by the user.

Output: final prompt sentence prepared for transmission.

The terminal collects the characters from the input control, may apply basic validation or tokenization, and passes the text to the prompt management module as a completed prompt.

### Step 19:

The terminal constructs and sends a request to the generative AI model gateway. The terminal reads the endpoint uniform resource locator, authentication token, language setting, and privacy flags from its internal configuration.

Input: final prompt sentence from Step 18 and configuration parameters from Step 10. Output: network request message sent to the generative AI model gateway.

The terminal formats the prompt sentence and associated parameters into a structured request body, sets network headers including an authorization header and privacy metadata, and sends the request over a secure communication protocol. The terminal then waits for a response.

### Step 20:

The server-side generative AI model gateway processes the prompt sentence. The model gateway receives the request, validates the authentication token, and applies privacy-related routing rules depending on the opt-out flag.

Input: network request containing prompt sentence, authentication token, and privacy metadata.

Output: model input vector sequence and execution plan for the generative AI model. The model gateway tokenizes the prompt sentence, maps tokens to embedding indices, and constructs an input tensor for a transformer-based generative AI model. The gateway also decides whether to use a fast inference path, a cached response, or a full inference run based on similarity checks or other logic.

### Step 21:

The generative AI model generates a response based on the prompt sentence. The model performs multiple layers of linear transformations, attention-weight computations, and nonlinear activations to compute probability distributions for output tokens.

Input: input tensor sequence and model parameters.

Output: generated token sequence representing the model's response text.

The model iteratively selects tokens using the probability distributions, subject to decoding strategies such as greedy selection or beam search, until an end-of-sequence condition is met. The model gateway converts the token sequence back into a text string.

### Step 22:

The model gateway returns the response to the terminal. The server that hosts the model gateway encapsulates the generated text in a structured response body and transmits it through the network back to the terminal.

Input: generated response text from the generative AI model.

Output: network response message delivered to the terminal.

The server sets appropriate response codes, includes metadata such as token count or processing time, and sends the message via the same secure channel used for the request.

### Step 23:

The terminal displays the generated response to the user. The terminal receives the network response, parses the response body, and extracts the generated text.

Input: network response message from Step 22.

Output: displayed content on the terminal screen and optional interaction options.

The terminal renders the text in a result area of the user interface and may provide buttons for copying the text, editing the text, or using it in another application such as an email client.

The terminal may also store the pair of prompt sentence and response text in a local history for later review.

### Step 24:

The terminal and the server update interaction logs and usage history. The terminal writes an entry for the completed interaction, including the length of the prompt sentence, the length of the generated response, and timing information, to the local log. The server may receive summarized interaction metrics for emotion estimation and system monitoring.

Input: interaction details from Steps 18 to 23.

Output: updated local log records and, optionally, aggregated usage data in the server database.

The server processes the aggregated usage data to compute statistics and to adjust future guidance and system parameters, such as recommending improved prompt sentence patterns or modifying default settings.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems that provide access to a generative AI model from a communication terminal typically rely on static privacy settings and coarse-grained consent mechanisms. In many implementations, configuration information for acquisition and recording of personal information is embedded in server-side software or in simple configuration files, and prompt sentences and responses exchanged with the generative AI model are logged by default for analysis and improvement of the model. As a result, once a user starts using the generative AI model, the system often acquires and stores personal information contained in natural language inputs and generated outputs without dynamically adapting to the user's current privacy preference or without appropriately preprocessing the content.

Furthermore, in existing architectures, the server generally treats opt-out as an external legal or administrative flag that is checked only at a high level (for example, at the account or service level), while the internal technical behavior of the system-such as logging, prompt preprocessing, or storage of dialogue history-remains largely unchanged. Even when an opt-out setting is present, the system may still log raw prompt sentences and responses in application logs, database tables, or analytics pipelines, because the logging components are not technically integrated with the privacy setting information. This leads to a situation where personal information may be stored in unintended locations despite the user having opted out. In addition, most prompt handling mechanisms in current systems do not perform fine-grained, context-aware preprocessing of prompt sentences and responses based on privacy settings. Personal information such as names, addresses, identifiers, or contact information is often included directly in prompts provided to the generative AI model, and the same raw content may be recorded in logs. This creates technical risks in terms of data leakage, difficulty of enforcing deletion or anonymization, and increased complexity in compliance with data protection regulations.

Another problem is that users often do not understand how their inputs to a generative AI model are technically processed and stored. Existing interfaces may present generic privacy notices but do not expose, in a technically meaningful way, how opt-out affects logging, preprocessing, and storage behavior at the system level. Moreover, user interfaces rarely support natural language opt-out requests that are automatically recognized and bound to the underlying privacy control mechanisms. As a result, users have difficulty exercising fine-grained control over the handling of their personal information in real time while interacting with the generative AI model.

From a computer technology standpoint, there is thus a need for an improved server-side architecture that tightly couples configuration information, persistent privacy setting information, prompt preprocessing, logging behavior, and user interface generation. Such an architecture should allow the server to dynamically determine, at run time and on a per-user basis, whether and how to acquire, store, or anonymize personal information contained in prompt sentences and generated responses. There is also a need for a mechanism by which natural language prompt sentences expressing an opt-out intention can be automatically detected and translated into updates of the underlying privacy settings, without requiring the user to navigate separate configuration flows.

Accordingly, a technical problem to be solved by the present invention is to provide an information processing technique that improves the functioning of a computing system by (i) integrating configuration information and persistent privacy setting information into the core control logic for handling generative AI interactions, (ii) automatically preprocessing prompt sentences and responses to mask or delete personal information in accordance with an opt-out state, (iii) dynamically switching logging and storage formats between detailed and anonymized forms based on the opt-out state, and (iv) enabling the server to interpret natural language opt-out requests and to update privacy settings and system behavior in an automated and technically consistent manner, while providing explanatory visual information to the user through a communication terminal.

The specific processing by the specific processing unit 290 of the data processing device 12 in Example 2 is realized by the following means.

The present invention provides a server comprising a processor and at least one storage device storing instructions which, when executed by the processor, cause the processor to obtain configuration information indicating operating conditions of an information processing function including a generative AI model from a storage medium, parse the configuration information to extract configuration items relating to acquisition or recording of personal information, and determine a control state of handling of personal information by the generative AI model based on an extraction result; to connect to an information recording apparatus that stores privacy setting information associated with user identification information, refer to or update an opt-out state included in the privacy setting information, and manage, in a persistent manner, whether personal information is permitted to be acquired for each user; to generate display data including the opt-out state and privacy-related information based on the configuration information, in response to a request from a communication terminal, and transmit the display data to the communication terminal so as to cause the communication terminal to present options regarding acquisition of personal information; to receive selection information indicating permission or refusal of acquisition of personal information by a user from the communication terminal, update the privacy setting information in the information recording apparatus based on the selection information, and change operating conditions of logging processing and analysis processing for the generative AI model; to receive dialogue information including a prompt sentence input by the user, extract personal information candidates in the prompt sentence based on the privacy setting information and the configuration information, generate a preprocessed prompt sentence by masking or deleting the personal information candidates, and input the preprocessed prompt sentence to the generative AI model so as to cause the generative AI model to generate a response in accordance with a privacy protection state; to control whether to store a dialogue history including the dialogue information and response information obtained from the generative AI model in a non-stored form or in an anonymized stored form, in accordance with the opt-out state; to generate and record only statistical information that does not include personal information with respect to the prompt sentence and the response information when the opt-out state in the privacy setting information is enabled, and record detailed dialogue history including the dialogue information and the response information when the opt-out state is disabled, by automatically switching a recording format; and to perform analysis processing on a natural language prompt sentence input from the communication terminal to determine whether the prompt sentence includes an intention of requesting opt-out of personal information acquisition, automatically enable the opt-out state in the privacy setting information when it is determined that the intention of opting out is included, and transmit notification information indicating that the opt-out state has been enabled to the communication terminal. This enables the computing system to technically integrate per-user privacy preferences with configuration-driven control of generative AI interactions, to automatically sanitize prompt sentences and responses at the server before model invocation and logging, to dynamically switch between detailed and anonymized recording modes based on an opt-out state, and to interpret natural language opt-out requests as direct inputs to the underlying privacy control logic, thereby improving the functioning, security, and reliability of the computer system itself.

The term “system” refers to an arrangement including at least one processor and at least one storage device, and optionally including one or more communication terminals and one or more information recording apparatuses, that collectively execute the functions described in the claims.

The term “processor” refers to a hardware processing unit, such as a central processing unit or other processing circuitry, that executes machine-readable instructions to perform the functions described in the claims.

The term “storage medium” refers to any non-transitory, computer-readable medium, such as a semiconductor memory, magnetic storage, or optical storage, that stores configuration information or instructions for use by the processor.

The term “information processing function” refers to a set of operations executed by the processor, including at least generation, analysis, logging, and control of data related to interactions with a generative AI model.

The term “generative AI model” refers to an artificial intelligence model that generates content, including text or other data, in response to input data such as a prompt sentence. The term “configuration information” refers to data indicating operating conditions, parameters, or settings for the information processing function, including items relating to acquisition, recording, or handling of personal information.

The term “configuration item” refers to an individual field or parameter within the configuration information that specifies a particular aspect of system behavior, such as whether to acquire or record personal information.

The term “control state” refers to a logical state or set of parameters determining how the system handles personal information, logging, and analysis in relation to the generative AI model.

The term “personal information” refers to information that relates to an identified or identifiable individual, including, for example, names, contact details, identifiers, or similar data enabling identification.

The term “acquisition or recording of personal information” refers to operations in which personal information is obtained from user inputs or generated outputs and then stored or otherwise persisted by the system.

The term “information recording apparatus” refers to a hardware device or subsystem, such as a database server or storage system, that stores privacy setting information, dialogue history, or other data in a persistent manner.

The term “user identification information” refers to data that uniquely or quasi-uniquely identifies a user within the system, such as an account identifier, subscriber identifier, or similar token.

The term “privacy setting information” refers to data stored in association with user identification information that specifies preferences or restrictions relating to acquisition, processing, or storage of personal information.

The term “opt-out state” refers to a state within the privacy setting information indicating that acquisition or recording of personal information for a corresponding user is disabled or restricted according to a user's preference.

The term “communication terminal” refers to an electronic device, such as a smartphone, tablet, personal computer, or similar terminal, that communicates with the server to send and receive data, including prompt sentences and display data.

The term “display data” refers to data generated by the processor and transmitted to the communication terminal for presentation on a user interface, including representations of privacy options and related information.

The term “selection information” refers to data indicating a user's choice regarding permission or refusal of acquisition of personal information, transmitted from the communication terminal to the server.

The term “logging processing” refers to processing operations that record data, such as prompt sentences, responses, or metadata, into log storage for later reference, analysis, or monitoring.

The term “analysis processing” refers to processing operations that evaluate or process collected data, including prompt sentences and responses, to derive metrics, statistics, or insights related to system behavior or model performance.

The term “dialogue information” refers to information representing an interaction between a user and the generative AI model, including at least a prompt sentence and optionally additional contextual data.

The term “prompt sentence” refers to a natural language input or other structured input provided by a user to request content generation or processing by the generative AI model. The term “personal information candidate” refers to a portion of a prompt sentence or other data that is identified by the system as potentially representing personal information subject to protection or masking.

The term “preprocessed prompt sentence” refers to a modified version of a prompt sentence in which personal information candidates have been masked, deleted, or otherwise transformed according to privacy-related control.

The term “privacy protection state” refers to a state that reflects the active privacy-related controls for a user, including whether personal information is to be masked, deleted, acquired, or recorded.

The term “response information” refers to data generated by the generative AI model in response to a prompt sentence, including text or other content returned to the user.

The term “dialogue history” refers to a stored record of one or more interactions between a user and the generative AI model, including prompt sentences, response information, and associated metadata.

The term “non-stored form” refers to a mode of operation in which particular data, such as dialogue information or response information, is not persisted in storage beyond transient processing required to generate a response.

The term “anonymized stored form” refers to a mode of storage in which identifying elements are removed, masked, or generalized so that stored data cannot reasonably be linked to a specific identified or identifiable individual.

The term “statistical information” refers to data derived from one or more interactions, such as counts, aggregates, or distributions, that do not include personal information and do not permit identification of an individual.

The term “recording format” refers to a scheme or structure defining how data is stored, including whether detailed content, anonymized content, or only statistical information is recorded.

The term “visual information” refers to information intended for visual presentation, including text, images, graphics, or video content that explains system behavior or usage.

The term “video data” refers to digital data representing moving images, optionally including audio, used to provide explanations or tutorials regarding usage of the generative AI model and privacy settings.

The term “distribution request” refers to a request received from a communication terminal to transmit video data or other visual information for presentation to a user.

The term “natural language prompt sentence” refers to a prompt sentence expressed in a human language, such as a sentence or phrase, that can include a user's intention, including an intention to opt out of personal information acquisition.

The term “intention of requesting opt-out” refers to a semantic indication, contained in a natural language prompt sentence, that a user wishes to disable or restrict acquisition or recording of personal information.

The term “notification information” refers to data transmitted from the server to the communication terminal indicating a status or result, including at least that an opt-out state has been enabled or modified.

In one embodiment, a server, a terminal, and a user cooperate to implement a privacy-aware interaction system using a generative AI model. The server includes at least one processor, a main memory, a non-volatile storage device, and a network interface. The terminal includes an input/output interface and a graphical user interface. The user interacts with the system through the terminal by inputting natural language prompt sentences. The server uses a general-purpose processor such as a central processing unit executing an operating system, and a graphics processing unit for accelerating inference of a neural-network-based generative AI model. The server stores configuration information and software components in a non-volatile storage device such as a solid-state drive. The server executes an application program implemented in a high-level language, such as Python or a similar language, on a runtime environment that provides libraries for parsing structured data, accessing a relational database, and invoking a generative AI model.

The server uses a database management system, such as a relational database engine, as an information recording apparatus to store privacy setting information associated with user identification information, dialogue history, and statistical information. The server defines data structures such as a “users” table storing fields including a user identifier, an opt-out flag, and a timestamp; a “config” table or file storing keys and values representing acquisition and recording policies of personal information; and a “chat_logs” table storing prompt sentences, responses, and metadata in some embodiments.

The server stores a configuration file, such as a file in a structured text format, in the storage device. The configuration file contains configuration items for the generative AI model and for logging behavior. The configuration items include, for example, a flag indicating whether personal information may be recorded, a flag indicating whether conversation content may be used for analysis, a logging level, and an API endpoint for the generative AI model. The server loads the configuration file into memory, parses the file into an internal data structure such as a dictionary or key-value map, and extracts configuration items relating to acquisition or recording of personal information. By representing these items as explicit fields in a data structure internally, the server can evaluate, for each user and each request, whether personal information is permitted to be acquired or stored.

The server uses a generative AI model implemented as a neural network. In one embodiment, the generative AI model is a transformer-based language model having multiple layers of self-attention and feedforward sub-layers. Each transformer layer includes weight matrices for query, key, and value projections, and for output projections. The server stores model parameters, such as floating-point weight values and bias vectors, in a parameter store in the storage device, and loads these parameters into GPU memory for inference. The server receives tokenized prompt sentences as sequences of token identifiers, applies an embedding matrix to convert token identifiers into dense vectors, and then processes the vectors through the transformer layers. During inference, the server computes attention scores, normalizes them with a softmax operation, and accumulates weighted sums to generate context-aware representations, which are then transformed into output token probabilities. The server selects output tokens according to a decoding strategy, such as greedy decoding or sampling with temperature and top-k constraints.

The server uses training data and a training process to obtain the parameters of the generative AI model before deployment. In one embodiment, the server trains the model using mini-batch gradient descent, an error function such as cross-entropy between predicted token distributions and target tokens, and a weight update algorithm such as stochastic gradient descent with momentum or an adaptive method. The server optionally applies regularization and data augmentation, such as random masking or shuffling of training sentences, to improve generalization. These details define the internal structure and operation of the generative AI model, and provide a technical basis for the model's behavior when processing prompt sentences.

The server integrates a privacy-control module into the data flow to and from the generative AI model. The server stores privacy setting information per user in the database, including an opt-out state indicating whether acquisition or recording of personal information is allowed. The server caches frequently accessed privacy settings in main memory, such as in a hash map keyed by user identifier, to reduce database queries and improve response time. When the server receives an interaction from a terminal, the server retrieves the relevant privacy setting from the cache or from the database. This retrieval changes the server's behavior in a concrete way: the logging module, preprocessing module, and generative AI invocation module use the retrieved opt-out state to choose data paths and processing routines. The server uses a dedicated preprocessing module to analyze prompt sentences and identify personal information candidates. The server executes pattern-matching algorithms using regular expressions to detect sequences that resemble email addresses, telephone numbers, postal addresses, numeric identifiers, or sequences of capitalized tokens that likely correspond to names. In another embodiment, the server uses a statistical or neural tagging model trained for named-entity recognition. The tagging model may be a bidirectional recurrent network, a transformer-based encoder, or a conditional random field operating on token-level features such as word embeddings, character-level features, and part-of-speech tags. The tagging model outputs labels, such as “person,” “location,” or “contact,” for each token in the prompt sentence.

The server applies rule-based logic to combine detection signals from regular expressions and from the tagging model. The server may associate a confidence score with each detected segment and treat segments with a confidence score above a threshold as personal information candidates. For such segments, the server generates a preprocessed prompt sentence by replacing the segments with placeholder tokens such as “[NAME]”, “[EMAIL]”, or by deleting them. When the opt-out state is enabled, the server ensures that only the preprocessed prompt sentence is passed to the generative AI model and that the original prompt sentence is not stored in long-term logs. This preprocessing changes the actual token sequence input into the neural network and thereby reduces the likelihood that the model processes or memorizes personal identifiers.

The server uses a logging module that supports multiple recording formats. In one embodiment, the server has an internal configuration structure indicating whether to store detailed dialogue history, anonymized dialogues, or aggregated statistics only. When the opt-out state is disabled, the server records, in the chat_logs table, entries that include the full prompt sentence, the generated response, timestamps, and possibly additional attributes such as token counts or model parameters used. When the opt-out state is enabled, the server refrains from inserting the raw text into the chat_logs table and instead records only anonymized or aggregated data, such as the length of the prompt sentence, the total number of tokens processed, or the category of the request. By structuring the data storage in this way, the server reduces the amount of sensitive information stored, decreases storage requirements, and simplifies later data management tasks such as deletion, encryption, and backup.

The server uses a specific data flow that connects the configuration manager, the privacy setting store, the preprocessing module, the generative AI model, and the logging module. The server loads base configuration information at startup and listens for requests from terminals. For each interaction, the server resolves the current configuration and privacy settings for the user, applies preprocessing rules to the input, invokes the generative AI model with the processed input, and registers the result in the logging subsystem according to the determined recording format. This integrated data flow improves computational efficiency and consistency because privacy-related decisions are computed once per interaction and reused across modules, avoiding redundant checks and inconsistent behavior.

The terminal acts as a communication endpoint and a user interface. The terminal executes a client application that issues requests to the server over a network using a protocol such as HTTPS. The terminal displays privacy options and explanations to the user, based on display data provided by the server. The display data includes textual descriptions of the opt-out state, available choices, and explanations of how personal information is handled. The terminal renders these elements using graphical components such as text labels, buttons, and toggles. When the user selects an option, the terminal formats selection information indicating permission or refusal of acquisition of personal information and sends this information to the server.

The terminal provides an input field where the user can type prompt sentences addressed to the generative AI model. For example, the user may input a prompt sentence such as: “I would like to opt out of personal information collection.” or

“Please explain how I can use this generative AI model safely without sharing my personal information.” or

“Write a short email asking my colleague to reschedule a meeting, without including any personal information about me.”

The terminal transmits these prompt sentences to the server in a structured request. The terminal also receives the response information generated by the generative AI model from the server and displays the response in a chat-style interface. The terminal may display an indicator showing that opt-out is active, for example, by showing a label such as “Privacy protection enabled” when the user's opt-out state is enabled.

The user interacts with the terminal by selecting privacy options and entering prompt sentences. The user can express privacy preferences either through explicit selection in a settings screen or through natural language statements embedded in prompt sentences. For example, when the user inputs a sentence such as “I would like to opt out of personal information collection,” the server analyzes the sentence using a natural language intent analysis module. This module may employ a classification model, such as a neural network trained to classify prompt sentences into categories including “opt-out request,” “general query,” or “content generation request.” The classification model may be implemented as a shallow neural network applied to sentence embeddings or as a transformer-based encoder. The server uses a training dataset of labeled sentences to train this classifier, optimizing a loss function such as cross-entropy and updating weights using a gradient-based algorithm. When the server determines that the prompt sentence includes an intention of requesting opt-out, the server automatically updates the privacy setting information in the database by setting the opt-out state to enabled for the corresponding user identifier. The server updates internal caches and then generates notification information for the terminal, indicating that opt-out has been activated. This behavior allows the system to respond to the user's natural language instructions in a technically integrated way, without requiring manual navigation to separate configuration screens.

The server provides video data and other visual information to help the user understand the generative AI model and the privacy mechanisms. The server stores video files on a storage device and associates each video with a resource identifier. The server responds to distribution requests from the terminal by streaming the video data in segments and adjusting transmission parameters such as chunk size and bitrate according to network conditions. The video content explains, for example, how prompt sentences are processed, how personal information is masked, and how opt-out affects logging and storage. By providing this information, the server assists the user in creating safe and effective prompt sentences and in understanding the technical consequences of privacy settings.

The server improves computer technology by altering the internal operation of the computing system in a specific and non-conventional manner. The server does not simply accommodate a legal opt-out flag but integrates per-user privacy preferences into the core control path of model invocation and logging. This integration reduces unnecessary data acquisition, minimizes writes to persistent storage, and optimizes database usage by limiting storage of sensitive content. The server uses structured configuration items to avoid repeated parsing and to enable condition-based branching in code paths, which results in reduced latency and improved throughput under high load.

The preprocessing of prompt sentences based on privacy settings also contributes to technical improvement. By performing masking and deletion of detected personal information candidates before the prompt is tokenized and fed into the generative AI model, the server reduces the entropy and dimensionality of input tokens associated with sensitive information. This can lead to more stable model behavior, reduce the risk of overfitting to rare personal identifiers, and improve the reliability of responses in terms of not echoing specific personal details. Moreover, the use of a specialized tagging model and rule-based combination logic achieves higher detection accuracy than simple keyword-based filtering, thereby increasing the precision and recall of personal-information identification within the data processing pipeline.

The server's logging design further improves data management and computational efficiency. By separating detailed logs from anonymized statistics, and by dynamically choosing the recording format per interaction based on the opt-out state, the server reduces the amount of data that must be indexed, searched, and archived. This leads to faster query times when operators or automated tools analyze performance metrics and error patterns, because the system stores a smaller volume of sensitive text and can focus on aggregated metrics. The reduced storage footprint also lowers I/O overhead on the database, which can result in improved transaction throughput.

The use of natural language opt-out detection introduces a non-conventional interaction mode with direct impact on system behavior. The server does not simply treat the generative AI model as an external component; instead, the server uses a dedicated classifier or a special control prompt pattern to interpret certain prompt sentences as configuration commands. For example, the server may treat sentences matching patterns such as “I want to opt out” or classified as intent “opt-out” as triggers for updating privacy settings. This dual-use of the generative AI-related interface, for both content generation and configuration control, allows the system to adjust internal variables and database fields in real time based on user language, thereby reducing configuration latency and avoiding separate configuration interfaces.

In an alternative embodiment, the server uses a local generative AI model deployed on the same hardware as the web application. In this case, the server loads the model parameters into GPU memory at process initialization and uses an optimized inference engine that supports batch processing and caching of intermediate activations. The server groups multiple user requests into batches to amortize overhead and uses the opt-out state to decide which prompts can be processed in shared batches and which require isolated processing to avoid cross-contamination of context. This batching strategy, combined with privacy-aware grouping, yields improved throughput and lower average latency compared to naive per-request processing.

In another embodiment, the server uses a different architecture for the personal information detection module, such as a rule-based engine with a decision tree or a finite-state machine that scans tokens and applies domain-specific heuristics. The server uses configuration information to load different rule sets for different jurisdictions or application domains. This flexibility allows the same basic architecture to be adapted to various privacy regulations while maintaining the integrated flow of configuration, preprocessing, logging, and response generation.

In yet another embodiment, the server uses a distributed database or key-value store for the privacy setting information and dialogue history, and uses a caching layer to replicate hot privacy records closer to the application layer. The server may implement a write-through or write-back caching strategy and use timestamps or version numbers in the privacy setting records to resolve conflicts and ensure consistency. These techniques further improve scalability, fault tolerance, and performance of the system when deployed across multiple physical machines or data centers.

The described embodiments demonstrate that the system is not limited to abstract data manipulation or business rules but provides concrete improvements in computer operation. The server modifies how configuration information is stored and evaluated, how input data is transformed before model invocation, how model outputs are logged and retained, and how user interfaces are generated and updated in response to real-time privacy states. These technical modifications affect memory usage, storage layouts, network communication patterns, and CPU and GPU utilization, leading to faster processing, reduced storage and network overhead, improved accuracy of personal information detection, and more predictable and secure behavior of the generative AI model within the computing environment.

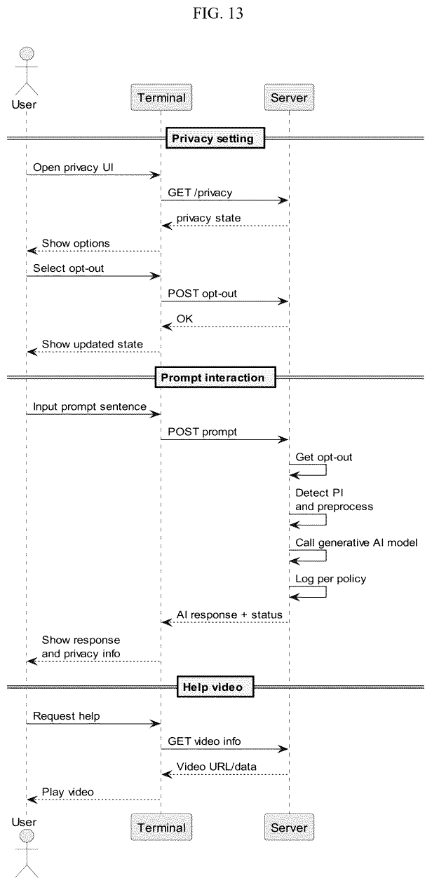

The following describes the processing flow using FIG. 13.

### Step 1:

The server loads base configuration information.

The server receives, as input, a configuration file stored on a storage medium and a set of default parameters compiled into the application. The server opens the configuration file, reads its contents into memory, and parses the contents into a structured data object, such as a key-value map. The server then performs data extraction to isolate configuration items related to acquisition, recording, and analysis of personal information, such as flags for logging prompts, logging responses, and enabling analytics. Based on these extracted values, the server computes, as output, an internal configuration structure that defines control states for the generative AI model and the logging module.

### Step 2:

The server initializes privacy setting caches.

The server receives, as input, connectivity information for an information recording apparatus and schema information for a privacy setting table. The server establishes a network connection to the information recording apparatus and executes a query to retrieve recent or frequently used privacy setting records, including user identifiers and opt-out states. The server converts the retrieved rows into in-memory entries stored in a hash map indexed by user identifier. The server outputs a cache data structure that allows constant-time lookup of opt-out states and reduces the frequency of database access during subsequent processing.

### Step 3:

The terminal fetches current privacy status and UI configuration.

The terminal receives, as input, a user identifier and a session token stored locally after authentication. The terminal constructs a request including the user identifier and the session token, and sends the request to the server to obtain current privacy settings and related configuration information. The terminal receives, as output, display data from the server that contains the current opt-out state, a textual description of privacy options, and UI directives such as which controls to render. The terminal parses this display data and prepares internal variables to drive the rendering of a privacy settings screen.

### Step 4:

The terminal renders a privacy settings interface.

The terminal receives, as input, the display data from the server and current UI layout definitions. The terminal allocates GUI components such as labels, buttons, and toggles, and populates their texts and initial states based on the received opt-out state and explanatory texts. The terminal performs layout computation to position the components on the screen and binds event handlers so that user actions will be captured. The terminal outputs a fully rendered privacy settings interface visible to the user, with interactive controls for selecting opt-out or non-opt-out states.

### Step 5:

The user selects a privacy option.

The user receives, as input, the visual display of the privacy settings interface on the terminal. The user observes the description of how personal information is acquired and stored, and then manipulates an input device, such as a touchscreen, to select “opt out” or “do not opt out.” The user may, for example, tap a toggle switch to change its position from off to on. This action generates, as output, an event captured by the terminal, which contains the new selection value and an association with the corresponding user identifier.

### Step 6:

The terminal sends selection information to the server.

The terminal receives, as input, the event containing the user's privacy choice and the associated user identifier. The terminal constructs a data object that encodes the user identifier and the selected opt-out state, and then serializes this object into a message payload. The terminal applies protocol-specific formatting, such as adding headers and encoding, and transmits the message to the server over a secure communication channel. The terminal outputs, to the server, a structured selection information message that can be processed to update privacy settings.

### Step 7:

The server updates the privacy setting in the information recording apparatus.

The server receives, as input, the selection information message from the terminal, including the user identifier and the new opt-out state. The server performs validation of the message, checking integrity, authentication, and format. The server then issues an update operation to the information recording apparatus, writing the new opt-out state into the privacy setting table for the corresponding user identifier. The server also updates its in-memory cache by replacing the old opt-out value with the new one. The server outputs an acknowledgment status, indicating whether the update succeeded or failed, and prepares it for transmission to the terminal.

### Step 8:

The terminal notifies the user of the updated privacy state.

The terminal receives, as input, the acknowledgment status from the server, including any message indicating that the opt-out state has been enabled or disabled. The terminal parses the acknowledgment and determines the outcome of the update operation. The terminal then generates a notification dialog or banner message, sets its text to explain the new privacy state, and displays it to the user. The terminal outputs a visual confirmation on the screen, allowing the user to recognize that the privacy setting has been successfully applied.

### Step 9:

The user enters a prompt sentence for interaction with the generative AI model.

The user receives, as input, a chat or interaction screen displayed by the terminal. The user types a natural language prompt sentence into an input field, such as: “I would like to opt out of personal information collection.” or “Please explain how I can use this generative AI model safely without sharing my personal information.” The user then activates a send control, such as a “Send” button. The user outputs, through the terminal, a prompt sentence string that expresses a query, a content-generation request, or a change in privacy preference.

### Step 10:

The terminal transmits the prompt sentence to the server.

The terminal receives, as input, the prompt sentence from the user and a current user identifier from its local state. The terminal constructs a message containing the user identifier, the prompt sentence, and any session metadata, and then serializes this message into a structured payload. The terminal sends this payload to the server over the network using a predefined protocol. The terminal outputs a request message to the server that instructs the server to process the prompt sentence with the generative AI model while considering the user's current privacy settings.

### Step 11:

The server resolves the user's opt-out state.

The server receives, as input, the request message containing the user identifier and the prompt sentence. The server performs a lookup in its in-memory cache for the corresponding privacy setting information. If the cache lacks a current entry, the server queries the information recording apparatus to retrieve the opt-out state and stores it in the cache. The server then computes, as output, a resolved opt-out state for the interaction and derives control flags indicating whether to permit logging of raw text, whether to perform masking, and whether to record only statistics.

### Step 12:

The server analyzes the prompt sentence to detect opt-out intent.

The server receives, as input, the prompt sentence and, optionally, the current opt-out state. The server passes the prompt sentence through an intent analysis module, which may encode the sentence into a vector representation using a neural encoder or recurrent network, and then apply a classifier to determine a predicted intent label. The classifier compares similarity of the encoded sentence against learned decision boundaries for classes such as “opt-out request” and “general query.” The server then calculates, as an output, a classification result with an associated confidence score. If the classification result indicates an opt-out intent above a threshold, the server flags the interaction as a request to change privacy settings.

### Step 13:

The server updates privacy settings based on natural language intent.

The server receives, as input, the classification result from the intent analysis module and the user identifier. If the intent is classified as an opt-out request, the server writes an update to the information recording apparatus to enable the opt-out state for the user, and it adjusts internal control flags accordingly. The server also generates a notification object indicating that the opt-out state has been enabled due to the user's prompt sentence. The server outputs updated privacy setting data and prepares a separate notification message that can be returned to the terminal alongside or in addition to the generative AI response.

### Step 14:

The server identifies personal information candidates in the prompt sentence. The server receives, as input, the prompt sentence and the resolved opt-out state. If the opt-out state is enabled or if configuration conditions require masking, the server applies a personal information detection module to the prompt sentence. The server uses algorithms such as regular expression matching to locate patterns for email addresses, phone numbers, or numeric identifiers, and uses a tagging model or rule-based engine to label tokens as potential personal entities. The server then aggregates contiguous labeled tokens and assigns each segment a confidence value. The server outputs a list of personal information candidate segments with their locations in the prompt sentence.

### Step 15:

The server generates a preprocessed prompt sentence.

The server receives, as input, the original prompt sentence and the candidate segment list. For each candidate segment that meets or exceeds a confidence threshold, the server applies a transformation rule, such as replacing the segment with a placeholder token or removing the segment from the text. The server concatenates the modified segments and unaffected portions of the text to produce a new sequence. As a result, the server outputs a preprocessed prompt sentence that contains masked or deleted personal information candidates and is suitable for input to the generative AI model under a privacy-protected mode.

### Step 16:

The server invokes the generative AI model with the preprocessed prompt sentence.

The server receives, as input, the preprocessed prompt sentence and the configuration flags for the generative AI model, such as maximum token length and temperature. The server converts the preprocessed sentence into tokens using a tokenizer, maps tokens to embeddings, and forwards the embeddings through the layers of the generative AI model. During this computation, the server performs matrix multiplications, attention computations, activation functions, and normalization operations, according to the transformer architecture. The server then decodes the model's output distribution into a response sequence using a decoding algorithm. The server outputs response information, which is a text sequence representing the model's answer to the input request.

### Step 17:

The server determines a recording format and logs according to the opt-out state.

The server receives, as input, the original prompt sentence, the preprocessed prompt sentence, the response information, and the resolved opt-out state. The server consults internal rules to determine whether to record full dialogue history, anonymized data, or only aggregated statistics. If logging is allowed and opt-out is disabled, the server composes a log entry including the original prompt sentence, the response text, user identifier, and timestamps, and stores this entry in the information recording apparatus. If the opt-out state is enabled, the server composes a reduced or anonymized record, such as token counts or category labels, and stores only this limited data. The server outputs stored log records and a record of statistics consistent with the user's privacy preferences.

### Step 18:

The server composes a response payload for the terminal.

The server receives, as input, the response information from the generative AI model, any notification information about privacy state changes, and status information about logging operations. The server constructs a response payload that includes the generated response text, indicators of the current opt-out state, and optional messages indicating that opt-out has been enabled or updated. The server serializes this payload into a transport format and sends it to the terminal. The server outputs a complete response message that delivers both AI-generated content and privacy-related feedback to the user.

### Step 19:

The terminal presents the response and privacy status to the user.

The terminal receives, as input, the response payload from the server. The terminal parses the payload to extract the response text, opt-out indicators, and notification messages. The terminal appends the response text to a chat display area, visually aligning it with the user's original prompt sentence, and updates any privacy indicators on the screen to reflect the reported opt-out state. The terminal may also display a separate notification banner stating that opt-out has been activated if such information is included. The terminal outputs an updated user interface that shows the conversation with the generative AI model and the current privacy configuration in an integrated manner.

### Step 20:

The terminal requests and displays instructional video content.

The terminal receives, as input, a user action requesting help or an explanation of the generative AI model and privacy settings. The terminal sends a distribution request to the server asking for specific video data or a list of available tutorials. The terminal receives, as output, video data or metadata describing available videos. The terminal decodes the video data and renders it on the display, showing content that explains safe prompt sentence creation and the impact of opt-out on data handling. This presentation supports the user in understanding the technical behavior of the system and in forming future prompt sentences that align with the desired privacy level.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer systems that provide access to generative AI models suffer from several technical limitations at the system and software-architecture level. First, configuration of communication terminals and back-end services for enabling the usage of a generative AI model is often performed manually or through static scripts. Such approaches do not adapt to heterogeneous terminal environments, evolving service policies, or user-specific constraints, and therefore require repeated human intervention, increase configuration errors, and introduce latency before the generative AI model can be used. Second, handling of personal-information opt-out is typically implemented as fixed, service-specific code or static user interface flows. These implementations cannot reliably interpret complex service terms, cannot scale to many services with frequently updated privacy policies, and cannot dynamically automate opt-out procedures across external services. This results in inconsistent data-protection behavior, increased processing overhead for developers and operators, and a higher risk of misconfiguration or non-compliance. Third, existing dialogue systems that combine generative AI models with user interfaces generally treat user emotion as an external, non-technical concern. Emotion recognition, if present, is often implemented in a silo and is not tightly integrated into the generation of machine-understandable control instructions. As a result, the system cannot systematically incorporate emotion context into the prompt sentences sent to the generative AI model, and cannot consistently adjust response style, content depth, or system behavior based on detected emotion. This leads to inefficient use of computation and network resources, for example by returning overly long or overly complex responses that do not match user state, and degrades the effectiveness and robustness of the overall human-machine interaction pipeline. Fourth, conventional systems for user support, such as inquiry routing and tutorial delivery, rely on predefined rule sets or static classification logic implemented in server-side code. These mechanisms are difficult to maintain as the number of services, inquiry categories, and educational scenarios grows. They also do not exploit the full expressive power of generative AI models to generate procedural instructions that can directly guide computer-executed workflows. Consequently, back-end servers must incorporate multiple hard-coded modules for inquiry classification, ticket routing, educational content selection, and user-interface control, which leads to duplication of logic, decreased maintainability, and sub-optimal resource utilization.

Moreover, known systems treat prompt sentences merely as user input content, and do not use them as a first-class control interface between the server and the generative AI model for orchestrating multi-step processes, such as terminal configuration, privacy operations, communication with external services, and dynamic content adaptation. Without a unified mechanism to generate, manage, and interpret such control-oriented prompt sentences, the server cannot delegate higher-level planning and procedure generation to the generative AI model in a reliable and structured manner. This limits the ability of the computer system to automatically construct and update processing pipelines in response to changing environments, policies, and user states.

Accordingly, there is a need for an improved computer-implemented system and server architecture that (i) uses a processor to systematically generate prompt sentences as machine-interpretable control instructions for a generative AI model, (ii) automatically configures communication terminals and privacy settings based on analysis results returned from the generative AI model, (iii) integrates emotion recognition results into both dialogue generation and educational content control, and (iv) leverages the generative AI model to generate procedural information used to execute communication processing, database updates, user-interface control, and inquiry routing. Such a system should improve the technical operation of the computer network and server software stack by reducing manual configuration, centralizing control logic through prompt-driven orchestration, and dynamically adapting processing behavior to user context and external policy changes.

The specific processing by the specific processing unit 290 of the data processing device 12 in Application Example 2 is realized by the following means.

The present invention provides a server comprising a processor configured to generate prompt sentences that instruct configuration of communication terminals, opt-out analysis and execution for personal-information acquisition, emotion-aware dialogue control, educational content control, and inquiry routing, and to execute, based on procedure information returned from a generative AI model in response to the prompt sentences, at least one of communication processing with external services, database update processing, and user interface display control processing. This enables a computer-implemented system in which the server automatically constructs and adapts multi-step processing workflows through prompt-driven interaction with the generative AI model, thereby improving terminal configuration efficiency, privacy-policy handling, emotion-adaptive dialogue generation, and support operations in a manner that enhances the overall performance, scalability, and robustness of the underlying computer infrastructure.

The term “processor” refers to a hardware or virtual computation unit, such as a central processing unit, a microprocessor, or a processing core of a server or virtual machine, that executes machine-readable instructions to perform logical operations, data processing, and control functions.

The term “communication terminal” refers to an electronic device, such as a mobile device, a tablet device, a wearable device, or a personal computer, that provides a user interface and network connectivity for sending and receiving data with a server.

The term “communication device” refers to a hardware or software component, such as a network interface, a modem, or a communication module, that establishes and manages data communication between the communication terminal and the server over a communication network.

The term “generative AI model” refers to a machine-learning model or artificial intelligence model, such as a language model or a multimodal model, that generates output data including text, audio, or other content in response to input data or prompt sentences.

The term “prompt sentence” refers to a natural-language or structured instruction expression that is provided to the generative AI model to specify a requested operation, content generation task, analysis task, classification task, or procedure generation task. The term “terminal information” refers to data indicating a state or attribute of the communication terminal, including at least one of device type, operating system type, version information, network capability, available storage information, and installed software information.

The term “user information” refers to data associated with a user of the communication terminal, including at least one of user identification information, preference information, account information, and historical usage information.

The term “setting state” refers to a configuration condition of the communication terminal or of an application executed on the communication terminal, including at least one of network settings, application installation status, permission settings, and service connection settings. The term “usage environment of a generative AI model” refers to a set of conditions under which the communication terminal can access and utilize the generative AI model, including network connectivity, authentication configuration, application installation, and permission configuration.

The term “usage condition information” refers to data indicating conditions, rules, or terms for using an electronic transaction or a service, including at least one of service terms, privacy policies, consent requirements, and usage limitations.

The term “electronic transaction” refers to a commercial or service operation executed via a communication network, including at least one of purchase of goods, payment processing, subscription registration, and service activation.

The term “selection information of a user” refers to data indicating a choice made by the user, including at least one of an opt-out selection, an opt-in selection, a consent selection, and a preference selection regarding service usage or personal-information handling. The term “opt-out of personal information acquisition” refers to a process for disabling or limiting collection or use of personal information of the user, according to a choice or preference of the user or according to applicable policies or rules.

The term “procedure information” refers to information describing steps or operations to be executed by a computer system, including at least one of API call sequences, database update actions, user-interface changes, and remote service interactions.

The term “analysis result” refers to output data produced by the generative AI model in response to a prompt sentence, including at least one of classification information, decision information, extracted feature information, and generated procedure information. The term “audio data” refers to digital data representing sound acquired from the user, including at least one of speech signals, voice recordings, and prosodic features. The term “image data” refers to digital data representing visual information acquired from the user, including at least one of still images, video frames, and facial-expression images. The term “text data” refers to digital data representing characters or symbols input or generated in text form, including at least one of user messages, service terms, and log messages.

The term “emotional state” refers to a state or condition of a user's emotion inferred from sensor data or text data, including at least one of happiness, sadness, anger, nervousness, confusion, and neutrality.

The term “emotion recognition process” refers to a computational process that analyzes audio data, image data, or text data to determine an emotional state of the user, using at least one of pattern recognition, machine learning, or rule-based analysis.

The term “context information” refers to information representing a situation or condition in which the generative AI model is used, including at least one of emotional state, user history, device conditions, and current task information.

The term “dialogue response generation conditions” refers to parameters or constraints that specify how the generative AI model should generate a dialogue response, including at least one of tone, politeness level, detail level, length, and topic focus.

The term “response control information” refers to information used by the server or the communication terminal to control presentation of a dialogue response, including at least one of output format, display mode, timing of presentation, and use of audio output.

The term “external service” refers to a system or service outside the server, accessible over a communication network, including at least one of third-party application servers, payment services, privacy-management services, and content-delivery services.

The term “communication processing” refers to operations for exchanging data over a communication network, including at least one of sending requests, receiving responses, establishing sessions, and handling errors.

The term “database update processing” refers to operations for changing data stored in a storage system, including at least one of inserting records, updating records, deleting records, and managing transaction control.

The term “user interface display control processing” refers to operations for controlling visual or auditory output to a user, including at least one of generating screen layouts, displaying messages, presenting dialog boxes, and controlling media playback.

The term “inquiry sentence” refers to text input provided by a user that expresses a question, a complaint, a request for assistance, or another support-related message.

The term “category information” refers to classification data indicating a category to which an inquiry sentence or other data belongs, including at least one of a support category, a functional category, and a priority category.

The term “summary information” refers to condensed text representing an essential part of an inquiry sentence or another content, with redundant or detailed portions removed.

The term “inquiry process” refers to processing for handling an inquiry sentence, including at least one of registering a support ticket, routing to a handling entity, generating an automatic response, and updating status.

The term “educational content” refers to information intended for learning or training, including at least one of tutorial text, video content, audio guidance, interactive exercises, and example prompt sentences.

The term “distribution control information” refers to information that controls how educational content is supplied to the communication terminal, including at least one of content selection, delivery timing, streaming parameters, and presentation format. The term “learning history information” refers to data representing a record of a user's learning activity, including at least one of viewed content, interaction results, performance indicators, and timestamps.

The term “viewing state information” refers to data indicating a state of viewing by the user of educational video content, including at least one of play position, pause events, replay events, and completion status.

The term “educational video content” refers to moving-image content used for educational purposes, including at least one of recorded tutorials, animations, demonstrations, and screen-capture videos.

The term “playback section” refers to a specified segment or time interval of video content that is played back to the user.

The term “supplementary explanation” refers to additional explanatory content presented to the user, including at least one of overlay text, voice commentary, and additional examples. The term “example prompt sentences” refers to sample prompt sentences that demonstrate how to instruct the generative AI model for specific tasks or scenarios.

The term “remote setting service” refers to a service that performs configuration of communication terminals from a remote location over a communication network, without requiring local manual configuration on each communication terminal.

The term “sales location” refers to a place or environment in which communication terminals are sold or provided, including at least one of a retail store, an online sales environment, and a service counter.

The term “setting agency location” refers to a place or environment in which a setting support service for communication terminals is provided, including at least one of a service center, a call center, and a remote support facility.

The term “network setting” refers to configuration of communication parameters on a communication terminal, including at least one of wireless network identifiers, access keys, proxy settings, and connection preferences.

The term “application installation setting” refers to operations for installing, updating, or removing an application on a communication terminal, including at least one of selecting an application package, initiating installation, setting initial parameters, and verifying installation state.

The term “permission setting” refers to configuration of access rights for an application or process on a communication terminal, including at least one of granting or denying access to a sensor, storage, or communication function.

The term “control information for executing remote setting processing” refers to information used by the server to cause execution of configuration operations on a communication terminal via a communication network, including at least one of command sequences, configuration parameters, and execution conditions.

In one embodiment, the system includes a server, at least one terminal, and a communication network.

The server includes at least one processor, a main memory, a non-volatile storage device, and a network interface.

The terminal includes at least one processor, a memory, a display, input devices, and a network interface.

The server executes a server-side program on a computing platform such as a rack-mounted computer, a virtual machine, or a container instance running an operating system such as a general-purpose server operating system.

The server uses middleware such as a web application framework, a database management system, and an HTTP server to provide application functions.

The server stores user information, terminal information, and policy information in a relational database management system such as a generic SQL database.

The terminal executes a client-side program on a mobile operating system such as a smartphone operating system or a tablet operating system.

The terminal uses a display framework to render user interfaces and uses operating-system-provided application programming interfaces to control hardware components such as a wireless communication module, a camera, a microphone, and a speaker.

The server integrates a generative AI model as a service module.

The server, in one embodiment, uses a transformer-based neural network as the generative AI model.

The generative AI model includes a stack of self-attention layers, each layer including multi-head attention, feedforward sub-layers, layer normalization, and residual connections. The server stores model parameters, including weight matrices and bias vectors, in non-volatile storage and loads them into main memory at runtime.

The server trains the generative AI model by performing supervised learning and fine-tuning on domain-specific corpora.

The server minimizes a loss function such as a cross-entropy loss between predicted token distributions and ground-truth tokens.

The server performs weight updates using an optimization algorithm such as stochastic gradient descent with adaptive learning rates.

The server uses regularization techniques such as dropout and weight decay to improve generalization.

The server optionally performs instruction-tuning by providing pairs of prompt sentences and desired outputs and updating the model parameters so that the model generates procedure-oriented responses.

The server defines a feature representation for each input token as a high-dimensional vector using an embedding table and positional encoding.

The server passes the sequence of feature vectors through the transformer layers to compute context-aware feature representations.

The server obtains an output probability distribution over tokens at each position and selects tokens according to decoding rules such as beam search, top-k sampling, or nucleus sampling.

The server constrains decoding by adding control tokens or control phrases in the prompt sentence to force the model to output structured content such as lists of steps, JSON-like structures, or labeled sections.

The server uses the generative AI model as an internal planning module by providing prompt sentences that specify desired procedures.

The server generates prompt sentences that describe, in natural language, target operations such as terminal configuration, opt-out procedure execution, or inquiry classification. The server receives procedure information from the generative AI model in response to the prompt sentences.

The server interprets the procedure information as a sequence of machine-executable actions using a deterministic parser and a mapping table between textual phrases and API calls. The server, in one embodiment, uses prompt sentences including, for example:

“Generate a list of configuration steps to install and initialize a generative AI assistant on an Android device for a given user. Include app download, permission settings, and initial login.” or

“Start the opt-out procedure for this user. User ID: 12345, Service: XYZ e-Payment. Disable all optional tracking, advertising, and data-sharing options described in the following policy sections.”

or

“Classify the following inquiry into one of: network support, billing, account, app bug. Also summarize the main problem in one sentence.” or

“Generate five example prompt sentences that instruct a generative AI model to provide explanations at a beginner level.”

The server improves computer technology by offloading non-trivial planning and adaptation logic from static, hard-coded modules into a prompt-driven orchestration layer. The server thereby reduces the amount of specialized branching code and rule tables that would otherwise be stored and executed, reducing memory usage and code complexity. The server gains flexibility to deploy the same core program to heterogeneous terminal types because device-specific procedures are produced by the generative AI model at runtime rather than compiled into the server binary.

The server therefore increases maintainability and reduces configuration errors without increasing computational complexity of the core program.

The server stores terminal information as structured records in the database.

The server, for example, stores each terminal record with fields such as terminal identifier, operating system type, operating system version, network capability, installed application list, and permission state.

The server retrieves these records using indexed queries to compute a current setting state for each terminal.

The server compares the setting state with a target state required for using the generative AI model and identifies differences.

The server expresses the differences as parameters and inserts them into prompt sentences that ask the generative AI model to generate minimal procedures to transition from the current state to the target state.

The server, by using this delta-based approach, reduces the volume of data that must be described in prompt sentences and improves response latency.

The terminal sends terminal information to the server by invoking a server API and including device attributes obtained from operating-system APIs.

The terminal, for example, obtains operating system version information, a list of granted permissions, and the status of a network interface.

The terminal transmits this information using a compact representation such as a key-value map.

The server uses an emotion recognition engine as a separate module connected to the processor.

The server, in one embodiment, implements the emotion recognition engine using a neural network that combines a convolutional neural network for image data and a recurrent neural network or transformer for audio features.

The server converts audio waveforms into spectrogram features using a short-time Fourier transform, and converts image frames into normalized pixel matrices.

The server feeds these features into the neural network, which outputs a probability vector over emotion labels such as happy, sad, angry, nervous, confused, and neutral.

The server selects the emotional state with maximum probability if the confidence exceeds a threshold; otherwise, the server sets the state to a default neutral value.

The server stores the emotional state as part of context information used for subsequent prompt generation.

The terminal acquires audio data using a microphone and image data using a front-facing camera.

The terminal applies preprocessing such as down-sampling, noise reduction, and face detection to reduce data size and remove irrelevant regions.

The terminal transmits either preprocessed features or compressed raw data to the server. The terminal reduces communication load by adjusting sampling frequency and resolution when network conditions are poor.

The server integrates emotion recognition into prompt sentences to the generative AI model. The server inserts descriptors such as “The user is classified as nervous” or “The user appears confused about privacy terms” into prompt sentences.

The server, for example, generates a prompt sentence:

“The user is classified as nervous with high confidence. Respond in a calm and reassuring tone, avoid technical jargon, and limit the response to three short paragraphs. User message: Explain how this service uses my personal data in simple terms.”

The generative AI model, in this case, produces output that matches specified tone and length constraints, which are later enforced by the server through an output filter that truncates or rejects overlong results.

The system achieves a technical effect because the generative AI model operates under explicit constraints derived from quantified emotional states, leading to reduced output size and lower bandwidth usage for returning responses to terminals.

The server, by shortening responses when appropriate, reduces transmission time and processing time in the terminal's rendering engine, particularly on low-power devices. The server uses a structured data model for user inquiries.

The server receives, from the terminal, a free-form inquiry sentence.

The server constructs a prompt sentence instructing the generative AI model to output both a category label and a one-sentence summary.

The server maps the category label to an internal routing table that associates each category with a database queue or a service endpoint.

The server stores the summary as a compact indexable representation in the database. The server thereby reduces database storage overhead compared to storing entire inquiry texts as routing keys, and improves query performance when searching for similar inquiries. The server uses prompt-generated procedures to control external services and internal modules.

The server includes an interpreter module that parses natural-language procedure descriptions generated by the generative AI model.

The interpreter module extracts action verbs, resource identifiers, and parameter values and matches them to registered operation templates.

The server then triggers concrete operations such as calling a remote configuration API, updating a database field, or initiating a video streaming session.

The server implements a strict mapping between keywords and allowed operations to prevent arbitrary uncontrolled behavior, thereby preserving system predictability.

The terminal participates in configuration tasks based on instructions ultimately derived from the generative AI model.

The terminal receives a high-level instruction from the server such as “Set Wi-Fi SSID to HomeNetwork and password to password123.”

The terminal converts this instruction into operating-system-level API calls to change wireless network settings.

The terminal confirms successful configuration by verifying connection status and reporting the result back to the server.

The system thus leads to actual reconfiguration of physical communication interfaces, beyond mere data processing.

The server controls educational content for teaching users how to construct effective prompt sentences.

The server stores multiple educational video contents at different difficulty levels and with different tones in a video storage system or a streaming platform.

The server maintains metadata for each content item, including tags such as “beginner”, “intermediate”, “advanced”, “formal tone”, and “casual tone”.

The server records learning history information for each user, such as which videos the user has watched and how long the user viewed each section.

The server determines which educational content to present based on learning history, emotional state, and recent interaction performance.

The server generates a prompt sentence such as: “Given that the user is a beginner and has shown confusion during previous instructions, select or generate tutorial content that explains how to write a prompt sentence for a generative AI model, using simple language and short examples.”

The generative AI model may output a list of example prompt sentences and explanatory text. The server associates these outputs with existing video segments or overlays them as captions.

The server transmits distribution control information to the terminal, such as which video URL to stream, which time segment to start from, and what overlay text to display. The terminal presents example prompt sentences in conjunction with video playback. The terminal allows the user to copy an example prompt sentence into an input field with a single interaction.

The user may then modify the prompt sentence and send it to the server to test actual behavior of the generative AI model.

The server uses this interactive pattern to refine future educational content selection based on which examples the user chooses and which outputs the user accepts.

The system provides a technical improvement in data management and communication efficiency by unifying control of multiple functions-terminal configuration, opt-out execution, emotion-aware dialogue, educational content selection, and inquiry routing—through a common prompt-driven mechanism instead of independent modules with separate rule engines.

The server reduces duplication of parsing logic and classification logic by centralizing these in the generative AI model and its supporting interpreter.

The system thus reduces execution time for adding new service types or terminal models because new logic can be expressed as prompt sentences and interpreted results rather than by deploying new server binaries.

The server can be implemented in alternative ways.

The server, in another embodiment, uses a different neural network architecture for the generative AI model, such as a mixture-of-experts transformer, in which multiple expert subnetworks handle different task types such as procedure generation, classification, and summarization.

The server, in yet another embodiment, uses a locally hosted generative AI model rather than a remote service.

The server, in further embodiments, uses a graph-based data structure to represent procedures returned by the generative AI model, where nodes correspond to actions and edges correspond to dependencies.

The server can then perform graph-based optimization, such as reordering non-dependent actions to reduce total execution time or to cluster network operations to minimize the number of network round trips.

The terminal can also be implemented with alternative hardware.

The terminal, in one embodiment, is a wearable device such as smart glasses, where the display is a head-mounted display and where audio output is provided through bone-conduction speakers.

The terminal, in another embodiment, is an in-vehicle device controlling entertainment and navigation systems.

In each case, the terminal performs similar roles: capturing user input, sending relevant data to the server, executing device-specific configuration actions, and rendering AI-generated responses and educational content.

The system, by using the generative AI model as a planning and control component with prompt sentences as a standardized interface, achieves improved processing speed for multi-step operations, reduced complexity of server-side software, improved accuracy in mapping user preferences to concrete actions, and reduced communication load through emotionally adapted response length control.

The system therefore provides a concrete technological improvement beyond automation of human decision-making, by altering how the computer system itself organizes, generates, and executes control flows in a dynamic environment.

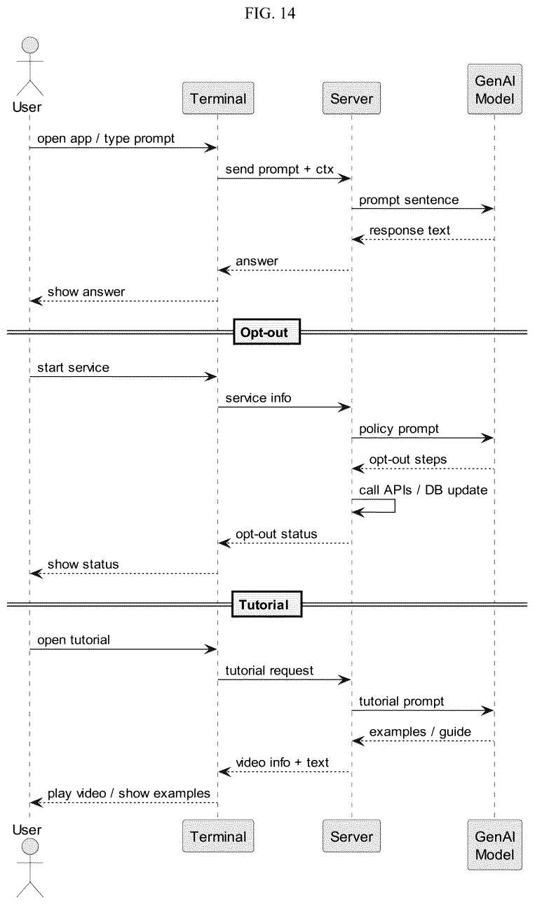

The following describes the processing flow using FIG. 14.

### Step 1:

The user activates an application on the terminal to use a generative AI model or to start an electronic transaction.

The terminal receives an input event indicating application launch and user selection (for example, “Use AI assistant” or “Start new service”).

The terminal reads device attributes and user account data from local storage as input, such as operating system version, permission status, and user ID.

The terminal formats these values into a structured request and outputs a first message to the server including terminal information and user information.

### Step 2:

The server receives the first message from the terminal as input.

The server performs data processing by querying a database using the user ID and terminal identifier to obtain stored terminal settings and service requirements.

The server compares the current terminal state with required conditions for using the generative AI model, computing a difference set (for example, missing application, missing permission).

The server outputs a configuration status response to the terminal, including flags indicating whether additional configuration is required and parameters describing the required changes.

### Step 3:

The terminal receives the configuration status response from the server as input. The terminal parses the flags and parameters and updates its internal state, determining whether to request user consent for configuration actions.

The terminal generates a UI dialog or screen that describes required actions (for example, “Install AI assistant app” or “Grant microphone permission”) and outputs visual elements on the display.

The user views the dialog and provides input by tapping “Allow”, “Install”, or “Cancel”.

### Step 4:

The terminal receives the user's consent or refusal as input.

The terminal performs data processing by mapping UI actions to boolean values and parameters, such as consent granted for specific permissions and configuration actions. The terminal outputs a second message to the server that includes consent information, terminal information, and requested service type.

### Step 5:

The server receives the second message as input.

The server aggregates terminal information, user information, and consent information into a structured context record.

The server generates a prompt sentence describing the required configuration procedure, for example: “Generate a list of configuration steps to install and initialize a generative AI assistant on an Android device for this user. Include app download, permission settings, and initial login.”

The server sends this prompt sentence as input to the generative AI model and outputs a model request over a model API.

### Step 6:

The generative AI model returns a textual description of configuration steps as output to the server.

The server receives the generated procedure text as input and parses the text using a deterministic parser that identifies actions, targets, and parameters.

The server performs data processing by mapping each identified action (for example, “install app”, “request permission”, “set language”) to predefined operation templates and serializing them into a machine-readable command list.

The server outputs a configuration command list to the terminal that describes concrete operations to be executed through operating system APIs.

### Step 7:

The terminal receives the configuration command list as input.

The terminal iterates through the command list and, for each command, calls corresponding operating system APIs (for example, package installation API, permission request API, network configuration API).

The terminal performs data operations such as writing new configuration values into system settings and verifying network connectivity or app installation status.

The terminal outputs a configuration result message to the server, containing success or failure statuses and any error codes.

### Step 8:

The server receives the configuration result message as input.

The server processes the results by updating tables in the database that represent the setting state of the terminal, for example setting flags indicating that the generative AI model is usable.

The server generates a short text message confirming completion or indicating remaining issues.

The server outputs a configuration completion response to the terminal.

### Step 9:

The terminal receives the configuration completion response as input.

The terminal updates the user interface to show that the generative AI assistant or service is ready to use.

The terminal outputs a main AI interaction screen where the user can enter a prompt sentence and optionally enable audio and video capture.

The user types a prompt sentence (for example, “Explain how this service uses my personal data in simple terms”) or speaks into the microphone.

### Step 10:

The terminal receives the user's prompt sentence and optional speech stream as input. The terminal converts speech to text using a speech recognition function if necessary, and normalizes the text (for example, trimming whitespace, converting character encoding). The terminal collects context data such as current service name and language preference. The terminal outputs an AI request message to the server including the prompt sentence, context data, and flags indicating whether emotion analysis is enabled.

### Step 11:

The terminal, when emotion analysis is enabled, acquires audio data and image data as input from the microphone and camera during or after user input.

The terminal performs preprocessing such as down-sampling, noise suppression, and face cropping to reduce data volume and remove irrelevant regions.

The terminal packages the resulting feature vectors or compressed media data as an emotion input payload.

The terminal outputs this emotion input payload to the server along with the AI request message.

### Step 12:

The server receives the AI request message and the emotion input payload as input. The server forwards audio and image features to an emotion recognition module, which performs pattern recognition using a trained neural network to compute probabilities for multiple emotional states.

The server computes an emotional state label by selecting the label with highest probability above a threshold and stores confidence as a numeric value.

The server outputs an emotion result used as context for subsequent prompt generation.

### Step 13:

The server receives the emotion result and the original prompt sentence as input. The server constructs an augmented prompt sentence that includes explicit conditions, for example: “The user is classified as nervous with high confidence. Respond in a calm, reassuring tone, avoid technical jargon, and limit the response to three short paragraphs. User message: Explain how this service uses my personal data in simple terms.”

The server may add constraints on maximum length, detail level, and style based on the emotional state and system configuration.

The server outputs this augmented prompt sentence to the generative AI model as a new model request.

### Step 14:

The generative AI model receives the augmented prompt sentence as input and performs internal computations over token embeddings and attention layers to generate a response text. The generative AI model outputs a sequence of tokens representing a dialogue response that should satisfy the constraints in the augmented prompt sentence.

The server receives the response text as input and applies post-processing such as truncation to enforce maximum length and filtering to remove prohibited content.

The server outputs a final answer text to the terminal.

### Step 15:

The terminal receives the final answer text as input.

The terminal formats the text as chat bubbles on the display, and optionally converts it to audio using a text-to-speech engine.

The terminal outputs the visual and auditory representation of the response to the user. The user reads or listens to the response and may provide another prompt sentence or react through buttons such as “Helpful” or “Not clear”.

### Step 16:

The user, during an electronic transaction, encounters a privacy-related confirmation screen on the terminal.

The terminal receives user navigation input that initiates a new service or transaction. The terminal sends service identifier, user identifier, and current privacy preference flags as input to the server.

The terminal outputs this transaction start message to the server.

### Step 17:

The server receives the transaction start message as input.

The server queries policy text and service terms from the database or a policy repository and obtains usage condition information for the service.

The server generates a prompt sentence instructing the generative AI model to analyze opt-out requirements, for example: “Analyze the following privacy policy and the user's preference. Determine where opt-out is necessary and output a structured description of required opt-out actions.”

The server outputs this policy analysis prompt sentence to the generative AI model and waits for an analysis result.

### Step 18:

The generative AI model receives the policy analysis prompt sentence as input and produces a textual description of required opt-out actions as output.

The server receives this description as input and parses it into internal representations such as a list of flags to disable and endpoints to call.

The server generates procedure information describing how to execute opt-out operations against external services and internal data stores.

The server outputs an opt-out command sequence and may log the analysis result for audit purposes.

### Step 19:

The server executes the opt-out command sequence as input to communication and database modules.

The server sends HTTP or other protocol requests to external service APIs to disable tracking or data sharing for the user, and simultaneously updates local database fields indicating opt-out status.

The server aggregates results from these sub-operations and determines whether the opt-out is fully successful or partially successful.

The server outputs an opt-out completion status message to the terminal, including human-readable status text.

### Step 20:

The terminal receives the opt-out completion status message as input.

The terminal updates the privacy pop-up or transaction screen to show explicit confirmation such as “Your opt-out preference has been applied.”

The terminal outputs a final status display to the user and resumes or concludes the transaction workflow accordingly.

The user confirms the status and continues using the service with updated privacy settings.

### Step 21:

The user opens a tutorial or learning section on the terminal to understand how to create effective prompt sentences.

The terminal receives this navigation input and reads local learning history markers indicating which tutorials were previously viewed.

The terminal outputs a tutorial request message to the server containing user ID, learning history data, and current language preference.

### Step 22:

The server receives the tutorial request message as input.

The server retrieves learning history information and viewing state information from the database and combines these with current emotional state if available.

The server generates a prompt sentence to the generative AI model, such as: “Given that the user is a beginner and has shown confusion, propose short tutorial content and example prompt sentences that teach how to use a generative AI model.”

The server outputs this tutorial selection prompt sentence to the generative AI model.

### Step 23:

The generative AI model receives the tutorial selection prompt sentence as input and generates educational text such as explanations and multiple example prompt sentences.

The server receives the generated educational content as input and maps it to available video assets by matching topics and difficulty tags.

The server constructs distribution control information specifying which video segments to stream and what overlay text or captions to present.

The server outputs this distribution control information and textual tutorial content to the terminal.

### Step 24:

The terminal receives the distribution control information and textual tutorial content as input.

The terminal starts streaming the specified video from a content server and overlays example prompt sentences on the screen.

The terminal outputs multimedia content to the user and allows the user to tap a “Use this prompt” button next to each example.

The user selects one example prompt sentence, such as “Write a blog article introducing a new technology to beginners and provide three practical examples,” and sends it to the AI assistant screen.

### Step 25:

The terminal receives the selected example prompt sentence as input.

The terminal fills the AI input field with this text and, upon user confirmation, sends it to the server as a new AI request.

The server receives this prompt sentence as input, forwards it to the generative AI model, and receives generated content as output (for example, a blog article).

The terminal finally outputs the generated content to the user, completing a loop in which educational guidance directly feeds into actual usage of the generative AI model.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

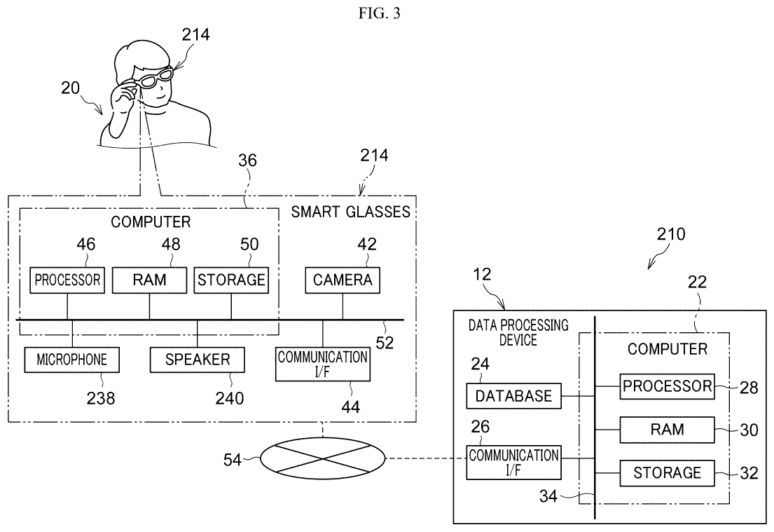

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

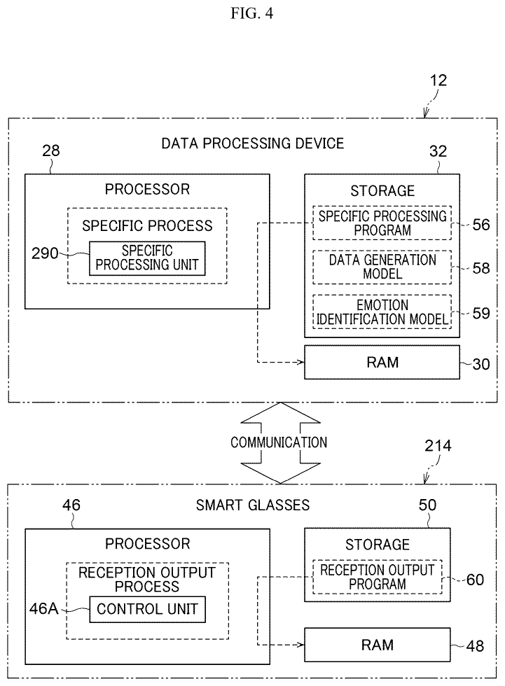

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

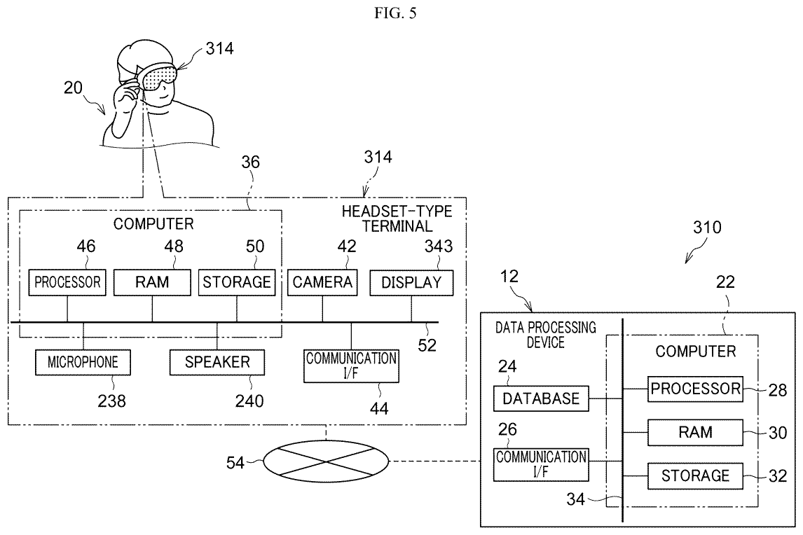

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

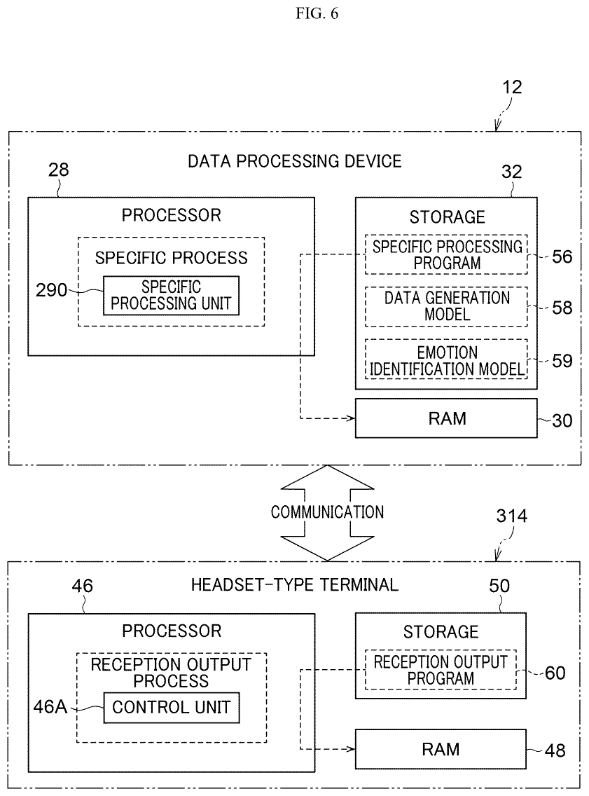

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

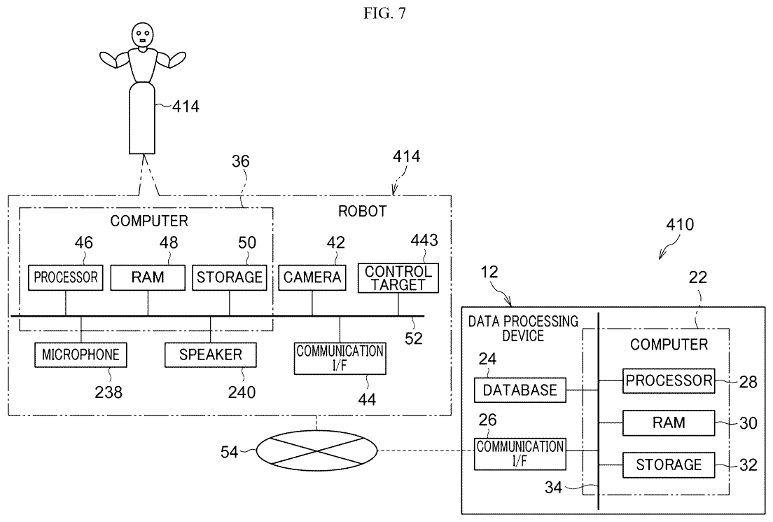

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

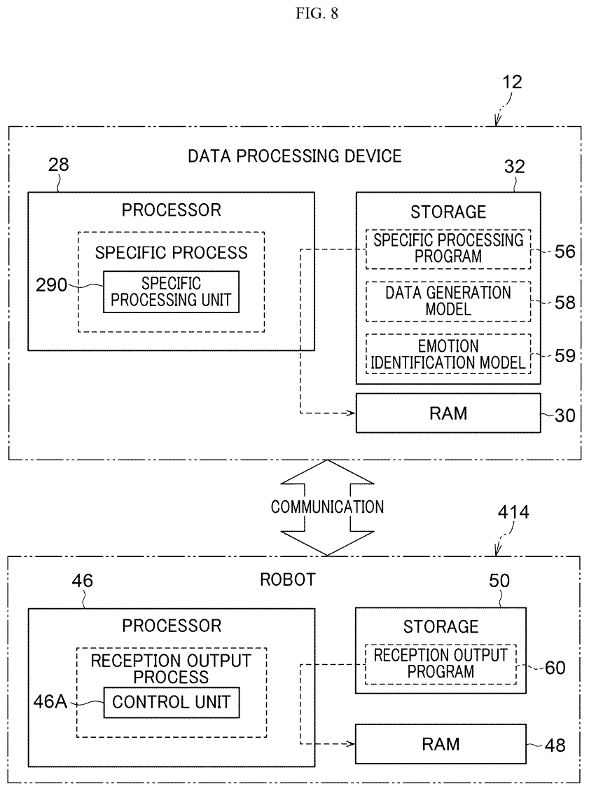

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

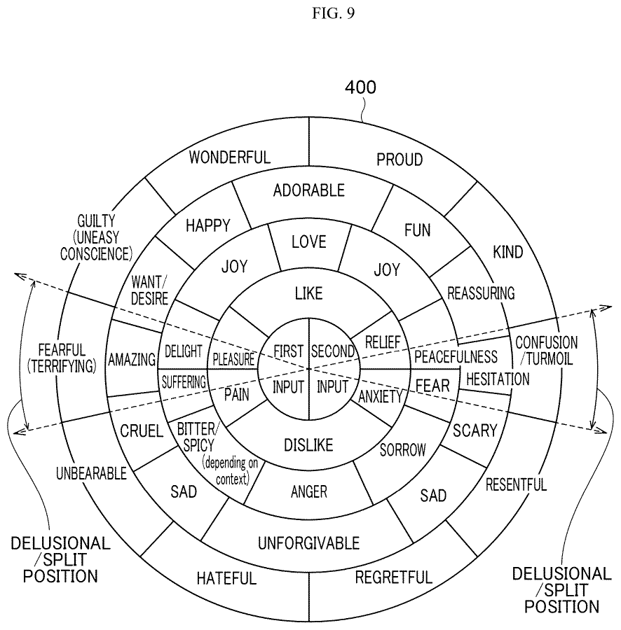

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

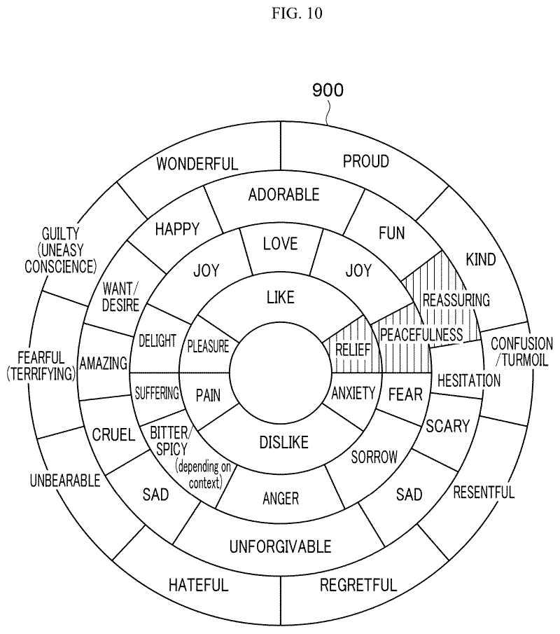

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire terminal attribute information and user attribute information from a communication device, determine introduction and configuration content of a generative information processing function for the communication device based on the terminal attribute information and the user attribute information, and generate configuration information processing commands including a result of the determination,
identify a generative information processing application program to be installed on the communication device based on identification information of an application program obtainable from an information distribution infrastructure, and generate application program acquisition information associated with the configuration information processing commands, add control information, into the configuration information processing commands, for causing a configuration execution program operating on the communication device to automatically execute installation processing of the generative information processing application program and connection setting processing to the generative information processing function,
generate privacy control information indicating permission or prohibition of storage of usage history information and prompt sentence information for the generative information processing function based on a selection state regarding acquisition of personal information included in the user attribute information, and apply the privacy control information to the configuration information processing commands and to the generative information processing application program,
store video information and text information explaining a usage method of the generative information processing function on the communication device, select reference identification information for the video information and the text information according to the terminal attribute information and the user attribute information, and provide the reference identification information in association with the configuration information processing commands,
receive a processing request including prompt sentence information transmitted from the communication device, determine processing execution conditions for a generative information processing model based on the prompt sentence information and the privacy control information, cause the generative information processing model to execute response information generation processing, and transmit a result of the response information generation processing to the communication device, and
acquire setting state information recorded on the communication device and setting change information by a user as a result of execution of the configuration information processing commands, and update the privacy control information and access conditions to the generative information processing model.

### (Supplementary 2)

The system according to supplementary 1,
wherein the processor is configured to
add, to the configuration information processing commands, screen configuration information and guidance control information for automatically displaying a support screen on the communication device when the generative information processing application program is started by the configuration information processing commands, the support screen explaining a method of inputting a prompt sentence to the generative information processing model, a method of interpreting response information from the generative information processing model, and a method of setting privacy options, and distribute the configuration information processing commands to the communication device.

### (Supplementary 3)

The system according to supplementary 1,
wherein the processor is configured to
acquire the terminal attribute information and the user attribute information from a management terminal used in a remote configuration support service, and perform remote introduction and automatic configuration of the generative information processing application program by relaying the configuration information processing commands and the application program acquisition information to the communication device via the management terminal.

### Application Example 1

### (Supplementary 1)

A system comprising a processor,
wherein the processor is configured to
identify a communication terminal based on terminal identification information acquired from a user by using an external connection interface, to transfer an application program that enables utilization of a generative artificial intelligence model to the communication terminal, and to automatically execute an installation process of the application program on the communication terminal,
to generate configuration information in a structured data format by referring to user attribute information and personal information handling policy information stored in a storage device, the configuration information including connection information to a generative artificial intelligence model, authentication information, language settings, and an opt-out setting for acquisition of personal information, and to transfer a configuration file including the configuration information to a predetermined area in the communication terminal,
to transmit a start instruction to the generative artificial intelligence application installed on the communication terminal, to acquire operation log information from the generative artificial intelligence application, and to analyze the operation log information to verify that the configuration file has been correctly read, that a connection state to the generative artificial intelligence model satisfies a predetermined condition, and that the opt-out setting for acquisition of personal information satisfies the predetermined condition, to transmit notification information to the communication terminal, the notification information including reference information to visual information data that explains a usage method of the generative artificial intelligence application on the communication terminal, and to generate explanation information in the visual information data that presents a method and precautions for creating a prompt sentence to be input to the generative artificial intelligence model, to generate a prompt sentence for performing proxy configuration of the communication terminal and enabling utilization of the generative artificial intelligence model,
to generate a prompt sentence for confirming an opt-out setting regarding acquisition of personal information and automatically executing a required procedure related to the opt-out setting, and
to generate a prompt sentence for recognizing a user emotion, analyzing the user emotion, and adjusting dialogue content and response style of the generative artificial intelligence model based on an analysis result of the user emotion.

### (Supplementary 2)

The system according to supplementary 1,
wherein the processor is configured to
provide the visual information data that explains the usage method of the generative artificial intelligence model, and to generate a prompt sentence for changing content or tone of expression of the visual information data in accordance with a user emotional state, a usage history, and a prompt sentence input status.

### (Supplementary 3)

The system according to supplementary 1,
wherein the processor is configured to
execute, in a configuration proxy service provided at a sales location or a service location, a remote installation process of the generative artificial intelligence application and a remote transfer process of the configuration file from an information processing apparatus installed at the sales location or the service location to the communication terminal, and to generate a prompt sentence corresponding to a progress state and a result of the processes.

### Example 2

### (Supplementary 1)

A system comprising a processor,
wherein the processor is configured to
obtain configuration information indicating operating conditions of an information processing function including a generative AI model from a storage medium, parse the configuration information, extract configuration items relating to acquisition or recording of personal information, and determine a control state of handling of personal information by the generative AI model based on an extraction result, and
connect to an information recording apparatus that stores privacy setting information associated with user identification information, refer to or update an opt-out state included in the privacy setting information, and manage, in a persistent manner, whether personal information is permitted to be acquired for each user, and
generate display data including the opt-out state and privacy-related information based on the configuration information, in response to a request from a communication terminal, and transmit the display data to the communication terminal so as to cause the communication terminal to present options regarding acquisition of personal information, and
receive selection information indicating permission or refusal of acquisition of personal information by a user, the selection information being transmitted from the communication terminal, update the privacy setting information in the information recording apparatus based on the selection information, and change operating conditions of logging processing and analysis processing for the generative AI model, and
receive dialogue information including a prompt sentence input by the user, extract personal information candidates in the prompt sentence based on the privacy setting information and the configuration information, generate a preprocessed prompt sentence by masking or deleting the personal information candidates, and input the preprocessed prompt sentence to the generative AI model so as to cause the generative AI model to generate a response in accordance with a privacy protection state, and
control whether to store a dialogue history including the dialogue information and response information obtained from the generative AI model in a non-stored form or in an anonymized stored form, in accordance with the opt-out state, and
transmit visual information including video data explaining a usage method of the generative AI model and an effect of the privacy setting to the communication terminal, in response to a distribution request for the video data from the communication terminal, so as to present to the user a method of creating a safe prompt sentence and contents of an opt-out function. (Supplementary 2)

The system according to supplementary 1,
wherein the processor is configured to
generate and record only statistical information that does not include personal information with respect to the prompt sentence and the response information for the generative AI model when the opt-out state in the privacy setting information is enabled, and record detailed dialogue history including the dialogue information and the response information when the opt-out state is disabled, by automatically switching a recording format.

### (Supplementary 3)

The system according to supplementary 1,
wherein the processor is configured to
perform analysis processing on a natural language prompt sentence input from the communication terminal to determine whether the prompt sentence includes an intention of requesting opt-out of personal information acquisition, automatically enable the opt-out state in the privacy setting information when it is determined that the intention of opting out is included, and transmit notification information indicating that the opt-out state has been enabled to the communication terminal.

### Application Example 2

### (Supplementary 1)

A system comprising a processor,
wherein the processor is configured to
generate a prompt sentence for instructing a setting process to construct a usage environment of a generative AI model in a communication terminal, based on terminal information and user information acquired through a communication device, and to determine a setting state of the communication terminal, and
generate a prompt sentence for causing a generative AI model to analyze a necessity of opt-out of personal information acquisition, based on usage condition information related to an electronic transaction or a usage service and selection information of a user, and to generate procedure information for automatically executing an opt-out process of personal information acquisition based on an analysis result acquired from the generative AI model, and execute an emotion recognition process to specify an emotional state, based on audio data and image data or text data acquired from the user, and generate a prompt sentence for specifying dialogue response generation conditions for the generative AI model using context information including the emotional state, and generate response control information for outputting a dialogue response acquired from the generative AI model in a manner corresponding to the emotional state, and
transmit, to the generative AI model, a prompt sentence describing, in natural language, a plurality of processing procedures related to the setting process of the communication terminal, the opt-out process of personal information acquisition, and the emotion recognition process, and automatically execute communication processing with an external service, database update processing, and user interface display control processing based on processing procedure information acquired from the generative AI model, and
generate a prompt sentence for instructing the generative AI model to classify and extract category information and summary information from an inquiry sentence input by the user, and distribute an inquiry process based on the category information acquired from the generative AI model, and
generate a prompt sentence for generating or selecting educational content related to a usage method of the generative AI model and a creation method of a prompt sentence, and output distribution control information of the educational content to the communication terminal. (Supplementary 2)

The system according to supplementary 1,
wherein the processor is configured to
generate a prompt sentence for dynamically adjusting content, difficulty, and tone of educational video content for the generative AI model, based on the emotional state of the user, learning history information, and viewing state information, and control a playback section of the video content, supplementary explanation, and presentation of example prompt sentences, based on an adjustment result acquired from the generative AI model. (Supplementary 3)

The system according to supplementary 1,
wherein the processor is configured to
generate a prompt sentence for causing the generative AI model to generate specific procedures for performing network setting, application installation setting, and permission setting for a plurality of types of communication terminals through a remote setting service provided at a sales location or a setting agency location of communication terminals, and output control information for executing remote setting processing for the communication terminals based on the specific procedures.

What is claimed is:

1. A system comprising:
circuitry configured to:
receive, via a communication interface coupled to a packet-switched network, terminal attribute information and user attribute information from a communication terminal;
determine configuration content for a generative information processing function on the communication terminal based on the terminal attribute information and the user attribute information, and generate configuration information processing commands comprising a result of the determination;
identify an application program to be installed on the communication terminal based on identification information obtained from an information distribution infrastructure, generate application program acquisition information associated with the configuration information processing commands, and add control information into the configuration information processing commands for causing the communication terminal to automatically execute installation processing and connection setting processing to the generative information processing function;
generate privacy control information indicating permission or prohibition of storage of usage history information based on a selection state included in the user attribute information, and apply the privacy control information to the configuration information processing commands to control logging and storage behavior of a generative neural network model;
estimate an emotional state of a user based on input data received from the communication terminal, and generate a prompt sentence for the generative neural network model that incorporates the estimated emotional state to adjust a dialogue mode and response tone; and
transmit the configuration information processing commands and the prompt sentence to the communication terminal via the communication interface.

2. The system according to claim 1, wherein the circuitry is configured to acquire the terminal attribute information comprising at least a device type identifier and an operating system version, and to acquire the user attribute information comprising at least a user identifier and a selection state with respect to data storage permissions.

3. The system according to claim 2, wherein the circuitry is configured to determine the configuration content by selecting, from a plurality of configuration templates stored in a storage device, a template matching the device type identifier and the operating system version, and to populate the template with values derived from the user attribute information.

4. The system according to claim 3, wherein the circuitry is configured to identify the application program by querying the information distribution infrastructure with a query comprising the device type identifier and a required capability identifier, and to embed a download address of the identified application program into the application program acquisition information.

5. The system according to claim 4, wherein the circuitry is configured to generate control information comprising an execution sequence specifying in order the installation processing of the application program and the connection setting processing, and to add the control information to the configuration information processing commands as an automated execution script for a configuration execution program operating on the communication terminal.

6. The system according to claim 1, wherein the circuitry is configured to generate the privacy control information by mapping the selection state of the user attribute information to a logging policy comprising at least a flag specifying whether usage history information and prompt sentence information are stored, and to embed the logging policy into both the configuration information processing commands and the application program.

7. The system according to claim 6, wherein the circuitry is configured to transmit the privacy control information to the generative neural network model operating on a server-side model execution environment via the communication interface, and to cause the generative neural network model to suppress or enable storage of interaction logs based on the logging policy.

8. The system according to claim 7, wherein the circuitry is configured to confirm that an opt-out procedure associated with the selection state has been executed by verifying a response received from the communication terminal via the communication interface, and to generate an updated privacy control information record reflecting the confirmed opt-out status.

9. The system according to claim 1, wherein the circuitry is configured to estimate the emotional state by applying an emotion identification model to at least one of voice data, text data, or image data received from the communication terminal, and to classify the emotional state into an emotional category from among a plurality of emotional categories.

10. The system according to claim 9, wherein the circuitry is configured to generate the prompt sentence by selecting a dialogue mode parameter based on the classified emotional category, and to construct the prompt sentence by encoding the dialogue mode parameter together with a user query and a task context as a structured input sequence for the generative neural network model.

11. The system according to claim 10, wherein the circuitry is configured to adjust the dialogue mode parameter such that when the estimated emotional state indicates anxiety the circuitry selects a simplified explanation mode and when the estimated emotional state indicates confidence the circuitry selects a detailed guidance mode.

12. The system according to claim 1, wherein the circuitry is configured to retrieve video information and text information explaining a usage method of the generative information processing function from a storage device, generate a prompt sentence for the generative neural network model based on the estimated emotional state, and control a playback section, supplementary explanation, and presentation of example prompt sentences of the video information based on a response from the generative neural network model.

13. The system according to claim 12, wherein the circuitry is configured to adjust at least one of a difficulty level, a pace parameter, or a tone of the video information based on the estimated emotional state and learning history information of the user retrieved from the storage device.

14. The system according to claim 1, wherein the circuitry is configured to transmit the configuration information processing commands to a configuration agent terminal located at a retail location via the communication interface, and to cause the configuration agent terminal to execute remote configuration processing on the communication terminal based on the configuration information processing commands.

15. The system according to claim 14, wherein the circuitry is configured to generate specific procedure instructions for network setting, application installation setting, and permission setting for a plurality of types of communication terminals by inputting a prompt sentence comprising terminal type information to the generative neural network model, and to transmit the specific procedure instructions to the configuration agent terminal.

16. The system according to claim 1, wherein the circuitry is configured to store configuration history information associating the terminal attribute information, the configuration information processing commands, and the privacy control information with a configuration session identifier in a storage device, and to retrieve the configuration history information to generate an updated configuration information processing commands when a subsequent configuration request is received from the communication terminal.

17. The system according to claim 16, wherein the circuitry is configured to detect a change in the terminal attribute information relative to the stored configuration history information, and to regenerate only configuration information processing commands associated with the changed attributes while reusing unchanged configuration information processing commands from the configuration history information.

18. A system comprising:
circuitry configured to:
receive, via a communication interface coupled to a packet-switched network, terminal attribute information comprising a device type identifier and an operating system version, and user attribute information comprising a user identifier and a data storage selection state, from a communication terminal;
determine configuration content for a generative information processing function by selecting a configuration template matching the device type identifier and operating system version, identify an application program by querying an information distribution infrastructure with the device type identifier and a required capability identifier, and generate configuration information processing commands incorporating an execution sequence for automated installation processing and connection setting processing;
generate privacy control information by mapping the data storage selection state to a logging policy specifying storage permissions for usage history information and prompt sentence information, and apply the logging policy to the configuration information processing commands and to a generative neural network model operating on a server-side execution environment;
estimate an emotional state of a user by applying an emotion identification model to voice data or text data received from the communication terminal, classify the emotional state into an emotional category, and generate a prompt sentence incorporating a dialogue mode parameter selected based on the emotional category; and
transmit the configuration information processing commands and the prompt sentence to the communication terminal via the communication interface.

19. The system according to claim 18, wherein the circuitry is configured to retrieve video information explaining a usage method of the generative information processing function from a storage device, and to adjust at least one of a difficulty level, a pace parameter, or a tone of the video information based on the classified emotional state by generating a control prompt for the generative neural network model and applying a response from the generative neural network model to video playback control parameters.

20. A method comprising:
receiving, via a communication interface coupled to a packet-switched network, terminal attribute information and user attribute information from a communication terminal;
determining configuration content for a generative information processing function on the communication terminal based on the terminal attribute information and the user attribute information, and generating configuration information processing commands comprising a result of the determination;
identifying an application program to be installed on the communication terminal based on identification information obtained from an information distribution infrastructure, generating application program acquisition information associated with the configuration information processing commands, and adding control information into the configuration information processing commands for causing the communication terminal to automatically execute installation processing and connection setting processing to the generative information processing function;
generating privacy control information indicating permission or prohibition of storage of usage history information based on a selection state included in the user attribute information, and applying the privacy control information to the configuration information processing commands to control logging and storage behavior of a generative neural network model;
estimating an emotional state of a user based on input data received from the communication terminal, and generating a prompt sentence for the generative neural network model that incorporates the estimated emotional state to adjust a dialogue mode and response tone; and
transmitting the configuration information processing commands and the prompt sentence to the communication terminal via the communication interface.
